(19) United States
(12) Patent Application Publication
(10) Pub. No.: US 2026/0116405 A1
(43) Pub. Date: Apr. 30, 2026

(54) SYSTEM AND METHOD FOR PROCESSING VEHICULAR OBSERVATION DATA

(71) Applicant: HERE Global B.V., Eindhoven (NL)

(72) Inventor: Dennis Scott WILLIAMSON, Wheaton, IL (US)

(21) Appl. No.: 18/931,896

(22) Filed: Oct. 30, 2024

(51) Int. Cl. B60W 50/04; B60W 40/09; B60W 50/00; B60W 60/00; G01C 21/00

(52) U.S. Cl. CPC B60W 50/045; B60W 40/09; B60W 60/00; G01C 21/3856; B60W 2050/0013

(57) ABSTRACT

A computer-implemented method for processing vehicular sensor data comprises collecting one or more sensor datapoints corresponding to one or more vehicle functions. Each sensor datapoint of the one or more sensor datapoints comprises an autonomous functionality status identifier of the respective vehicle function of the one or more vehicle functions. The method further comprises filtering each sensor data point into one of autonomous control data or manual control data to generate filtered data, based on the corresponding autonomous functionality status identifier of the respective sensor data point. Further, the method comprises generating at least one of a first dataset or a second dataset, based on the filtered data. The first dataset corresponds to the autonomous control data and the second dataset corresponds to the manual control data.

### TECHNOLOGICAL FIELD

The present disclosure generally relates to vehicular data processing and more particularly relates to methods and systems for optimizing vehicle functions and updating map databases using sensor data from autonomous and manual vehicle operations.

### BACKGROUND

In the evolving landscape of vehicle automation, the integration of advanced sensor data and automated systems is essential for enhancing driving safety and efficiency. Modern vehicles are increasingly reliant on automated functions such as steering, acceleration, and braking, which operate in varying degrees of autonomy. However, as these systems become more prevalent, it is crucial to understand how they interact with human drivers and the surrounding environment, requiring comprehensive data collection that goes beyond basic vehicle metrics.

One of the key challenges in this regard is distinguishing between human-driven actions and those governed by automation. Current sensor data, while being abundant, often lacks the context needed to differentiate between these modes of control. Such a context is crucial for several reasons—for example, a map update performed using sensor data captured while the vehicle was driven in autonomous control may lead to a circular loop where imprecise map data from the map leads to imperfect navigation control which in turn leads to incorrect observations that lead to incorrectly updating the map data. Similarly, where the performance of an autonomous function is to be ascertained, sensor data captured while autonomous control is off can lead to imbalanced tuning of the performance parameters by providers of such functionalities. Conventional terrestrial data capture systems do not track or report when vehicle automation is in use or whether it is dependent on map content potentially derived from previous driver behaviour. The absence of such knowledge leads to potential degradation of map content, end user experience, and driving safety.

Accordingly, there is a need to provide improved approaches for capturing vehicular observations that meets the challenges of high-end applications and leads to error-free downstream operations both at the mapping server as well as the vehicle. Also, there is a need for systems and methods that can efficiently and reliably process sensory observations for map data update to ensure its alignment with real-world environments.

### BRIEF SUMMARY OF SOME EMBODIMENTS

To address the aforesaid requirements, it is important to also record information about which vehicle functions are under human control at any given time and, when automation is in use, whether the control system is heuristic or dependent on map content. This nuanced data collection is vital for accurately mapping driving behaviors and improving the quality of automation systems.

This approach not only enables more precise map-making processes but also allows vehicle manufacturers to monitor and refine their automation systems by comparing them to human-driven behavior. Additionally, it provides a means to track changes in driver behavior, offering insights into how driving patterns evolve in response to the growing influence of vehicle automation. As such, there is a pressing need for systems that can integrate this data to enhance the accuracy of maps and the reliability of automated driving systems, ultimately contributing to a safer driving experience.

According to some embodiments, various vehicle control systems utilize sensor data to perform critical functions such as navigation, obstacle detection, and path planning. These systems, especially in the context of autonomous and semi-autonomous vehicles, rely heavily on the accuracy and reliability of sensor data to maintain optimal performance. The data collected from various sensors is used to train machine learning models that can make real-time decisions to enhance vehicle functions and update relevant databases, such as map databases. However, challenges arise when sensor data is inaccurate or inconsistent, leading to suboptimal model performance and unreliable map updates. Factors such as sensor noise, environmental conditions, and manual control interventions can contribute to the degradation of data quality.

Accordingly, there is a need for advanced methods and systems that can effectively filter and categorize sensor data based on its control status (autonomous or manual) to create specialized datasets. These datasets can then be used to train machine learning models that are tailored to improve specific vehicle functions or to accurately update map databases. Such an approach would address the challenges of data reliability and model performance, ultimately leading to more robust and efficient vehicle control systems.

In vehicle navigation contexts, the ability to accurately control and navigate a vehicle is heavily dependent on the quality of data representing the vehicle's operational status, including whether the vehicle is being controlled autonomously or manually. Accurate identification of these operational modes is critical, particularly when it comes to updating machine learning (ML) models that are used to optimize vehicle performance and update map databases. However, challenges arise in accurately distinguishing between autonomous control data and manual control data due to the complexity of vehicle operations and the varying conditions under which sensor data is collected.

To address these challenges, it is essential to implement a systematic approach for collecting, filtering, and classifying sensor data points based on their associated operational modes. Specifically, it is important to filter sensor data points into categories corresponding to either autonomous control or manual control, which then form the basis for generating specialized datasets. These datasets are used to train ML models, which play a crucial role in optimizing vehicle functions and ensuring that map databases accurately reflect real-world conditions.

Example embodiments described herein are directed towards providing solutions to the aforementioned challenges. Some example embodiments provide a framework for collecting sensor data points that include an autonomous functionality status identifier for each vehicle function. The collected sensor data is then filtered based on the autonomous functionality status identifier to classify the data as either autonomous control data or manual control data. This filtered data is subsequently used to generate first and second datasets, which are then employed in the training of respective ML models.

In some embodiments, the focus shifts towards a system designed specifically for updating map data, particularly in scenarios where new routes, such as roads or intersections, emerge over time. The system is integral for maintaining the accuracy of map databases, especially as road networks evolve due to construction or other changes in infrastructure. To address these dynamic conditions, the system employs advanced methodologies to ensure that the map data accurately reflects the real-world environment, thereby providing reliable navigation assistance to vehicles.

According to some embodiments, in one aspect a computer-implemented method for processing vehicular sensor data is provided. The method comprises collecting one or more sensor datapoints corresponding to one or more vehicle functions. Each sensor datapoint of the one or more sensor datapoints comprises an autonomous functionality status identifier of the respective vehicle function of the one or more vehicle functions. The method further comprises filtering each sensor data point into one of autonomous control data or manual control data to generate filtered data, based on the corresponding autonomous functionality status identifier of the respective sensor data point. Further, the method comprises generating at least one of a first dataset or a second dataset, based on the filtered data. The first dataset corresponds to the autonomous control data and the second dataset corresponds to the manual control data.

In additional embodiments, the method may further comprise controlling at least one of a first processor or a second processor. The first processor may be configured for training, using the first dataset, a first machine learning (ML) model to optimize a performance of the one or more vehicle functions. The second processor may be configured for training, using the second dataset, a second ML model to update a map database.

In additional embodiments, the method may further comprise determining driver behaviour data of a driver of at least one vehicle, based on the second dataset.

In additional embodiments, the method may further comprise controlling at least one of a first processor to optimize a performance of the one or more vehicle functions, based on the first dataset or a second processor to update a map database, based on the second dataset. In this regard, the first processor utilizes one or more of first heuristic algorithms, first statistical analysis or first user inputs corresponding to manual review of the first dataset to optimize the performance of the one or more vehicle functions. Additionally, or alternately, the second processor utilizes one or more of second heuristic algorithms, second statistical analysis or second user inputs corresponding to manual review of the second dataset to update the map database.

In another aspect, a system for processing vehicular sensor data is provided. The system may comprise a memory configured to store computer-executable instructions and one or more first processors configured to execute the computer-executable instructions. In this regard, the one or more first processors may collect one or more sensor datapoints corresponding to one or more vehicle functions. Each sensor datapoint of the one or more sensor datapoints comprises an autonomous functionality status identifier of the respective vehicle function of the one or more vehicle functions. The one or more first processors may further filter each sensor data point into one of autonomous control data or manual control data to generate filtered data, based on the corresponding autonomous functionality status identifier of the respective sensor data point. The one or more first processors may further generate at least one of a first dataset or a second dataset, based on the filtered data. The first dataset corresponds to the autonomous control data and the second dataset corresponds to the manual control data.

In additional system embodiments, the one or more first processors may further control at least one of a second processor or a third processor. The second processor may be configured for training, using the first dataset, a first machine learning (ML) model to optimize a performance of the one or more vehicle functions. The third processor may be configured for training, using the second dataset, a second ML model to update a map database.

In additional system embodiments, the one or more first processors may further determine driver behavior data of a driver of at least one vehicle, based on the second dataset.

In additional system embodiments, the one or more first processors may further control at least one of a second processor to optimize a performance of the one or more vehicle functions, based on the first dataset or a third processor to update a map database, based on the second dataset. In this regard, the second processor utilizes one or more of first heuristic algorithms, first statistical analysis or first user inputs corresponding to manual review of the first dataset to optimize the performance of the one or more vehicle functions. Additionally, or alternately, the third processor utilizes one or more of second heuristic algorithms, second statistical analysis or second user inputs corresponding to manual review of the second dataset to update the map database.

In yet another aspect, a computer program product is provided. The computer program product comprises at least one non-transitory computer-readable storage medium having stored thereon computer-executable instructions which when executed by a computer, cause the computer to carry out operations for processing vehicular sensor data. The operations may include collecting one or more sensor datapoints corresponding to one or more vehicle functions. Each sensor datapoint of the one or more sensor datapoints comprises an autonomous functionality status identifier of the respective vehicle function of the one or more vehicle functions. The operations may further include filtering each sensor data point into one of autonomous control data or manual control data to generate filtered data, based on the corresponding autonomous functionality status identifier of the respective sensor data point. Further, the operations may include generating at least one of a first dataset or a second dataset, based on the filtered data. The first dataset corresponds to the autonomous control data and the second dataset corresponds to the manual control data.

In additional embodiments, the operations may further comprise controlling at least one of a first processor or a second processor. The first processor may be configured for training, using the first dataset, a first machine learning (ML) model to optimize a performance of the one or more vehicle functions. The second processor may be configured for training, using the second dataset, a second ML model to update a map database.

In additional embodiments, the operations may further comprise determining driver behaviour data of a driver of at least one vehicle, based on the second dataset.

In additional embodiments, the first dataset excludes the manual control data, and the second dataset excludes the autonomous control data.

In additional embodiments, each sensor datapoint of the one or more sensor datapoints further comprises a functionality identifier of a respective vehicle function of the one or more vehicle functions, one or more timestamps associated with the respective vehicle function of the one or more vehicle functions, and one or more location identifiers associated with the respective vehicle function of the one or more vehicle functions.

In additional embodiments, the first dataset comprises a functionality identifier of at least one vehicle function of the one or more vehicle functions executed under autonomous mode, one or more timestamps corresponding to at least one of a start time of execution of the at least one vehicle function or an end time of execution of the at least one vehicle function, and one or more location identifiers corresponding to at least one of the start time of execution of the at least one vehicle function or the end time of execution of the at least one vehicle function.

In additional embodiments, the second dataset comprises a functionality identifier of at least one vehicle function of the one or more vehicle functions executed under manual mode, one or more timestamps corresponding to at least one of a start time of execution of the at least one vehicle function or an end time of execution of the at least one vehicle function, and one or more location identifiers corresponding to at least one of the start time of execution of the at least one vehicle function or the end time of execution of the at least one vehicle function.

In additional embodiments, the one or more sensor datapoints corresponding to the one or more vehicle functions are collected from one or more sensors comprising at least one of a camera, a lidar, a millimetre wave radar, a GPS, or an inertia measurement unit (IMU), a wheel speed sensor, a speed sensor, an acceleration sensor, a steering angle sensor, a rain sensor, or an ambient light sensor.

In additional embodiments, the one or more vehicle functions comprise at least one of one or more vehicle maneuver functions or one or more vehicle auxiliary functions.

In additional embodiments, the one or more vehicle maneuver functions comprise at least one of cruise control functions, braking functions, lane assist functions, steering functions, gear shift functions using stick shift and clutch, paddle shifters, or automatic transmission, or driving functions.

In additional embodiments, the one or more vehicle auxiliary functions comprise at least one of headlight control functions, wiper control functions, heating, ventilation and air conditioning (HVAC) control functions, window defrost function, or SOS functions.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 illustrates a block diagram showing a network environment of a system for generating and/or processing vehicular observations, in accordance with one or more example embodiments;

FIG. 2 illustrates a block diagram of the system of FIG. 1, in accordance with one or more example embodiments;

FIG. 3A illustrates a block diagram showing an exemplary format of map data stored in the map database, in accordance with one or more example embodiments;

FIG. 3B illustrates a block diagram showing another format of the map data stored in the map database, in accordance with one or more example embodiments;

FIG. 3C illustrates a block diagram showing yet another format of the map data stored in the map database, in accordance with one or more example embodiments;

FIG. 4A illustrates a terrestrial data capture system for processing vehicular observations;

FIG. 4B illustrates a feedback loop created due to the processing of vehicular observations by the terrestrial data capture system of FIG. 4A;

FIG. 4C illustrates an exemplary format of vehicular observation data generated by the system of FIG. 2, in accordance with one or more example embodiments;

FIG. 4D illustrates an exemplar framework for processing the vehicular observation data of FIG. 4C, in accordance with one or more example embodiments;

FIG. 5A illustrates a system architecture for collecting sensor data from various sensors, in accordance with one or more example embodiments;

FIG. 5B illustrates a flowchart describing data filtering for segregating vehicular observations, in accordance with one or more example embodiments;

FIG. 6 illustrates an exemplary structure of vehicular observation datasets, in accordance with one or more example embodiments;

FIG. 7 illustrates some exemplary vehicular functions in accordance with one or more example embodiments;

FIG. 8 illustrates a flowchart of a method for processing vehicular observations, in accordance with one or more example embodiments;

FIG. 9A illustrates a flowchart of a method for updating map data using vehicular observations, in accordance with one or more example embodiments; and

FIG. 9B illustrates a flowchart of a method for adjusting vehicular function quality using vehicular observations, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses, systems, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

Modern vehicles are increasingly reliant on automated functions such as steering, acceleration, and braking, which operate in varying degrees of autonomy. Furthermore, there are now several vehicular functions that can be fully executed in autonomous mode. Also, since vehicles now have a plethora of data capturing instruments embodied thereupon, they provide essential data for several end use applications including map making, driver behavioral analysis, evaluating the quality of vehicular functions during autonomous performance, and the like. However, not all end use applications operate upon the same kind of data provided by the vehicles. Particularly, while some applications require vehicular observations captured during autonomous operation of the vehicle, others may desire only those observations that are captured when the vehicular control is under manual mode. However, data capturing systems such as the sensory system of a vehicle or road side units on a road segment do not have any provision to record which observation was captured under what kind of vehicle operation (autonomous or manual). As such, downstream applications for the observations are devoid of any information that defines such a context.

Therefore, conventional solutions lack this context needed to differentiate between these modes of control. For example, conventional terrestrial data capture systems do not track or report when vehicle automation is in use or whether it is dependent on map content potentially derived from previous driver behaviour. The absence of such knowledge leads to potential degradation of map content, end user experience, and driving safety.

Example embodiments described herein provide technical solutions tailored for generating and recording contextual information for vehicular observations. The contextual information specifies which vehicle functions are under human control at any given time and, when automation is in use, whether the control system is heuristic or dependent on map content. Such a nuanced data collection is vital for accurately mapping driving behavior and improving the quality of automation systems. Some example embodiments utilize the contextual information associated with vehicular observations to process the observations for critical end-use tasks such as map making, automation refinement, etc. with high accuracy. Armed with the systems and methods of various example embodiments, navigation service providers are able to provide highly accurate navigation assistance to vehicles. Also, armed with the systems and methods of various example embodiments, vehicular service providers such as original equipment manufacturers (OEMs) are able to evaluate, calibrate, and improve the automation capabilities of various functionalities provided with vehicles.

Some example embodiments provide a system, a method, and a computer program product for updating a map database from sensor data collected from various vehicles. When such updated map data is utilized for navigation assistance, it provides precise, accurate, and nearly true representations of the road objects situated along designated routes. Essentially, the map data is characterized by its richness and comprehensive information content, ensuring high accuracy. Thus, the exemplary embodiments disclosed herein introduce substantial advancements to the mapping and navigation technology domain.

Moreover, these embodiments facilitate real-time updates to the system without interrupting the vehicle's normal operations. By leveraging the continuous data flow from existing sensors, the system dynamically adapts to changing conditions without the need for external data inputs or manual interventions. This integrated approach not only enhances operational efficiency but also ensures that the vehicle maintains optimal performance with minimal latency. The following sections will further detail the mechanisms by which these improvements are realized, with reference to accompanying figures for comprehensive understanding.

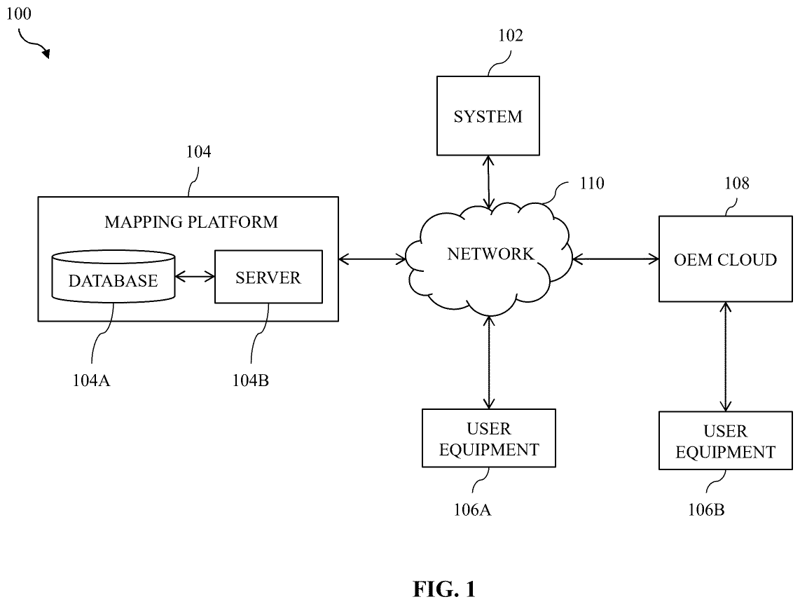

FIG. 1 illustrates an exemplary network environment 100 of a system 102 for processing vehicular observations. The system 102 may be communicatively coupled via the network 110 to a mapping platform 104, a user equipment 106A, and/or an OEM cloud 108. The OEM cloud 108 may be communicatively coupled to the user equipment 106B. The components described in the network environment 100 may be further broken down into more than one component such as one or more sensors or application in user equipment (such as the user equipment 106A and/or 106B) and/or combined together in any suitable arrangement. Further, it is possible that one or more components may be rearranged, changed, added, and/or removed without deviating from the scope of the present disclosure.

The network environment 100 is structured to enable efficient data exchange and processing, ensuring that map-related services and functionalities are consistently maintained and updated. The system 102 serves as the primary processing unit, central to managing and handling data across the network. In an exemplary embodiment, the system 102 is versatile and can be implemented in multiple configurations depending on the specific requirements of the application. For example, the system 102 may be embodied as a cloud-based service, a cloud-based application, a cloud-based platform, a remote server-based service, a remote server-based application, a remote server-based platform, or a virtual computing system. As such, the system 102 may be configured to operate inside the mapping platform 104 and/or inside at least one of the user equipment 106A and the user equipment 106B. In each of such embodiments, the system 102 may be communicatively coupled to the components shown in FIG. 1 to carry out the desired operations and wherever required modifications may be possible within the scope of the present disclosure.

For instance, the system 102 may be embodied as a cloud-based service or application, where it operates remotely, utilizing cloud computing resources to manage and process map data. This cloud-based implementation allows the system 102 to scale efficiently, handle large volumes of data, and support a wide range of users across different geographical locations. Alternatively, the system 102 may be implemented as a remote server-based service, where it operates from a dedicated server, providing specialized processing capabilities for the mapping platform 104 and user equipment 106A and 106B. This remote server-based configuration is particularly beneficial for scenarios where high-performance computing is required, or where the system 102 needs to operate independently from local hardware resources. Furthermore, the system 102 may also be configured as a virtual computing system, leveraging virtualization technologies to create a flexible and adaptable environment. In this embodiment, the system 102 may be dynamically allocated computing resources based on real-time demands, ensuring optimal performance and resource utilization. Such a virtual computing system may operate for example, within the mapping platform 104 inside the server 104B, or within the database 104A, providing a seamless integration with the platform's existing infrastructure.

Additionally, or alternately, the system 102 may be configured to operate within the user equipment 106A or 106B, such as in-vehicle navigation systems or mobile devices, allowing it to directly interact with end-users and provide real-time map updates and navigation assistance to them. In some embodiments, the system 102 may be embodied within the user equipment 106A or 106B, either as a standalone application or as an integrated component of an in-vehicle navigation system. This configuration allows the system 102 to operate closely with the user equipment's hardware and software, enabling it to process data locally and provide immediate feedback to the user. For example, in an in-vehicle navigation system, the system 102 can continuously monitor the vehicle's position, analyse road conditions, and update the navigation route in real-time based on the latest map data received from the mapping platform 104. This level of integration ensures that the navigation system remains accurate and reliable, even in dynamic environments.

According to some embodiments, the system 102 may be implemented in a vehicle, where the vehicle may be an autonomous vehicle, a semi-autonomous vehicle, or a manually driven vehicle. In the context of autonomous or semi-autonomous vehicles, the system 102 plays a crucial role in ensuring that the vehicle's navigation and control systems are provided with the most up-to-date and accurate map data. This is essential for the vehicle to make informed decisions about routing, obstacle avoidance, and traffic management. In manually driven vehicles, the system 102 enhances the driver's navigation experience by providing real-time updates and alerts, helping to improve safety and efficiency on the road.

In an embodiment, the system 102 may be deployed in a consumer vehicle or a probe vehicle, and/or a ground truth collection vehicle to collect sensor data specifically for creating observations associated with one or more objects. Such vehicles may be equipped with or be communicatively coupled to advanced sensors and data collection systems that capture detailed information about road conditions, traffic objects, posted signs, lane markings, road edges, and other road objects. The data collected by these vehicles may be processed by the system 102 to create accurate sensory observations, which may then be used to update the map database 104A within the mapping platform 104. This process ensures that the map data remains current and reflective of real-world conditions, providing users with reliable navigation and routing information.

The one or more objects may correspond to one or more road objects or one or more landmarks. As used herein, the one or more road objects may correspond to road obstacles, traffic objects, posted signs (e.g., road signs), lane markings, road edges, and/or the like. As used herein, the one or more landmarks may correspond to physical objects, celestial objects, and/or POIs. The physical objects may include statues, buildings, walls, trees, and/or the like. The POIs may include restaurants, gas stations, museums, shopping malls, hospitals, and/or the like. The celestial objects may include stars, comets, and/or the like. Hereinafter, the term “object(s)” may be used to refer to any physical body that exists within an environment of a sensor device capable of providing observations associated with such a physical body. Without limitation, such objects may include “road object(s)” and/or “landmark(s)”. As used herein, observation data or observation associated with an object may correspond to raw or processed sensor data corresponding to the object.

In yet another embodiment, the system 102 may be implemented within an OEM (Original Equipment Manufacturer), such as the OEM cloud 108. The OEM cloud 108 serves as a centralized hub for processing and distributing data related to the vehicles coupled to the OEM cloud 108. When implemented in this manner, the system 102 benefits from the cloud's advanced data processing and storage capabilities. The OEM cloud 108 may also be responsible for anonymizing any data received from vehicles before it is processed by or sent to the mapping platform 104. This anonymization process ensures that sensitive information is protected and complies with privacy regulations, while still allowing the system 102 to perform its functions effectively. According to some embodiments, when the system 102 is embodied within the OEM cloud 108, the system 102 performs evaluation and calibration of one or more vehicular functionalities provided by the OEM to the associated vehicles.

In various embodiments, the system 102 may invoke the mapping platform 104 for performing one or more actions such as navigation, map making, or map update. The mapping platform 104 includes the map database 104A and the mapping server 104B. The map database 104A stores all the map-related data, including node data, road segment data, points of interest (POI) data, and road object data. The server 104B is responsible for managing data requests, processing information, and facilitating communication between the map database 104A, the system 102, and the user equipment 106A/106B. This combination of components ensures that the map data is accurate, up-to-date, and accessible to all users within the network environment.

In some other embodiments, the system 102 may be embodied as or within the server 104B of the mapping platform 104 and therefore may be co-located with or within the mapping platform 104. The mapping platform 104 may comprise the map database 104A (also referred to as geographic database 104A) for storing map data and a processing server 104B for carrying out the processing functions associated with the mapping platform 103. The map database 104A may store, as the map data: node data, road segment data or link data, point of interest (POI) data, and/or object data. The map database 103a may also store, as the map data, cartographic data and/or routing data.

According to some example embodiments, the link data may be stored in link data records, where the link data may represent links or segments representing roads, streets, or paths, as may be used in calculating a route or recorded route information for determination of one or more personalized routes. The node data may be stored in node data records, where the node data may represent end points corresponding to the respective links or segments of the road segment data. One node represents a point at one end of the respective link and the other node represents a point at the other end of the respective link. The node at either end of a link corresponds to a location at which the road meets another road, e.g., an intersection, or where the road dead ends. An intersection may not necessarily be a place at which a turn from one road to another is permitted but represents a location at which one road and another road have the same latitude, longitude, and elevation. In some cases, a node may be located along a portion of a road between adjacent intersections, e.g., to indicate a change in road attributes, a railroad crossing, or for some other reason. The link data and the node data may represent a road network used by vehicles such as cars, trucks, buses, motorcycles, and/or other entities.

Additionally, the map database 104A may store path segment and node data records, or other data that may represent pedestrian paths or areas in addition to or instead of the vehicle road record data, for example. The links/road segments and nodes may be associated with attributes, such as geographic coordinates and other navigation related attributes, as well as POIs, such as fuelling stations, hotels, restaurants, museums, stadiums, offices, auto repair shops, buildings, stores, parks, etc. The navigation related attributes may include one or more of travel speed data (e.g. data indicative of a permitted speed of travel) on the road represented by the link data record, a travel direction data (e.g. data indicative of a permitted direction of travel) on the road represented by the link data record, the linear feature data on the road represented by the link data record, the road lane detection data on the road represented by the link data record, street address ranges of the road represented by the link data record, the name of the road represented by the link data record, and the like.

According to some example embodiments, the object data stored in the map database 103a may include ground truth data associated with the one or more objects and/or data related to the one or more objects. In various embodiments, the ground truth data associated with the one or more objects may include map statuses of the one or more objects. For instance, a map status of an object may either correspond to a presence state or an absence state of the object. In a case where the map status of an object corresponds to the presence state, the ground truth data associated with the object may indicate a presence of the object in the map data. Alternatively, when the map status of the object corresponds to the absence state, the ground truth data associated with the object may indicate an absence of the object in the map data. In various embodiments, the ground truth data associated with the one or more objects may be derived from the sensor data collected from the ground truth collection vehicle(s) and/or the probe vehicle(s). The data related to the one or more objects may include object type information of the one or more objects, location information of the one or more objects, map identity information of the one or more objects, and/or the like.

Additionally, the map database 104A may also include data about the POIs and their respective locations in the POI records. The map database 104A may further include data about places, such as cities, towns, or other communities, and other geographic features such as bodies of water, mountain ranges, etc. Such place or feature data may be part of the POI data or may be associated with POIs or POI data records (such as a data point used for displaying a city). In addition, the map database 104A may include event data (e.g., traffic incidents, construction activities, scheduled events, unscheduled events, etc.) associated with the POI data records or other records of the map database 104A.

The map database 104A may be maintained by a content provider e.g., a map developer. By way of example, the map developer may collect the map data to generate and enhance the map database 104A. There may be different ways used by the map developer to collect data, such ways including obtaining data from other sources, such as municipalities or respective geographic authorities. In addition, the map developer may employ field personnel to travel by vehicle (also referred to as a dedicated vehicle) along roads throughout a geographic region to observe features and/or record information about them, for example. Also, remote sensing, such as aerial or satellite photography, may be used to collect the map data. In some example embodiments, the map data in the map database 104A may be stored as a digital map.

According to some embodiments, the map database 104A may be a master map database stored in a format that facilitates updating, maintenance and development. The data in the production and/or delivery formats may be compiled or further compiled to form geographic database products or databases, which may be used in end user navigation devices or systems.

For example, the map data may be compiled (such as into a platform specification format (PSF format)) to organize and/or configure the data for performing navigation-related functions and/or services, such as route calculation, route guidance, map display, speed calculation, distance and travel time functions, navigation instruction generation and other functions, by a navigation device, such as by the user equipment 106A and/or 106B. The navigation-related functions may correspond to vehicle navigation, pedestrian navigation, navigation instruction suppression, navigation instruction generation based on user preference data or other types of navigation.

As mentioned above, the map database 104A may be a master geographic database, but in alternate embodiments, the map database 104A may be embodied as a client-side map database and may represent a compiled navigation database that may be used in or with end user equipment such as the user equipment 106A and/or the user equipment 106B to provide navigation and/or map-related functions. For example, the map database 104A may be used with the user equipment 106A and/or the user equipment 106B to provide an end user with navigation features. In such a case, the map database 104A may be downloaded or stored locally (cached) on the user equipment 106A and/or the user equipment 106B.

The processing server 104B may comprise processing means, and communication means. For example, the processing means may comprise one or more processors configured to process requests received from the user equipment 106A and/or the user equipment 106B. The processing means may fetch map data from the map database 104A and transmit the same to the user equipment 106B via the OEM cloud 108 in a format suitable for use by the one or both of the user equipment 106A and/or the user equipment 106B. In one or more example embodiments, the mapping platform 104 may periodically communicate with the user equipment 106A and/or the user equipment 106B via the processing server 104B to update a local cache of the map data stored on the user equipment 106A and/or the user equipment 106B. Accordingly, in some example embodiments, the map data may also be stored on the user equipment 106A and/or the user equipment 106B and may be updated based on periodic communication with the mapping platform 104 via the network 110.

The network 110 may be wired, wireless, or any combination of wired and wireless communication networks, such as cellular, Wi-Fi, internet, local area networks, or the like. In one embodiment, the network 110 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In some example embodiments, the user equipment 106A and the user equipment 106B may be any user accessible device such as a mobile phone, a smartphone, a portable computer, and the like that are portable in themselves or as a part of another portable/mobile object such as a vehicle. The user equipment 106A and 106B may comprise a processor, a memory, and a communication interface. The processor, the memory, and the communication interface may be communicatively coupled to each other. In some example embodiments, the user equipment 106A and 106B may be associated, coupled, or otherwise integrated with a vehicle, such as an advanced driver assistance system (ADAS), a personal navigation device (PND), a portable navigation device, an infotainment system and/or other device that may be configured to provide route guidance and navigation related functions to the user. In such example embodiments, the user equipment 106A and 106B may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user equipment 106A and 106B. For example, the user equipment 106A and 106B may be configured to execute and run mobile applications such as a messaging application, a browser application, a navigation application, and the like.

In one embodiment, at least one user equipment such as the user equipment 106A may be directly coupled to the system 102 via the network 110. For example, the user equipment 106A may be a dedicated vehicle (or a part thereof) for gathering data for development of the map data stored in the map database 104A. In another embodiment, at least one user equipment such as the user equipment 106B may be coupled to the system 102 via the OEM cloud 108 and the network 110. For example, the user equipment 106B may be a consumer vehicle (or a part thereof) and may be a beneficiary of the services provided by the system 102. In some example embodiments, one or more of the user equipment 106A and 106B may serve the dual purpose of a data gatherer and a beneficiary device. At least one of the user equipment 106A and 106B may be configured to capture sensor data associated with the link/road segment, while traversing along the link/road segment. For example, the sensor data may include image data associated with the one or more road objects along the link/road segment, among other things. The sensor data may be collected from one or more sensors in the user equipment 106A and/or 106B. As disclosed in conjunction with various embodiments disclosed herein, the system 102 may update the map data of the map database 104A using the sensor data. According to some other embodiments, one or both of the user equipment 106A and 106B may be terrestrial data capture device that is movable or stationary along a path between two points. For example, the user equipment 106A or 106B may be a roadside unit, a sensor constellation such as traffic cameras or any suitable means that can collect data from the surroundings of the system 102.

In operation, the system 102 may be configured to perform processing of a plurality of datapoints provided by any of the user equipment 106A and 106B. According to some embodiments, the system 102 may also generate vehicular observation data corresponding to the data captured by the user equipment 106A/106B. The vehicular observation data amalgamates vehicular observations along with auxiliary information relevant for processing the vehicular observations. In this regard, the auxiliary information may record data about which vehicle functions are under human control at any given time and, when automation is in use, whether the control system is heuristic or dependent on map content, and the like. According to some embodiments, the vehicular observation data may be transmitted to applications that perform further processing on the vehicular observations. Examples of such applications may include the mapping platform 104 or the OEM cloud 108. In some alternate embodiments, the system 102 may receive the vehicular observation data from another data capture system and perform suitable processing to update the map database 104A or another database inside the OEM cloud 108.

The generation of the vehicular sensor data is described hereinafter. The user equipment 106A/106B may capture a plurality of data corresponding to a plurality of parameters and variables relevant for carrying out operations for an associated vehicle. Such a data capture may be performed in discrete or continuous manner. At least some of these captured data may be clustered in suitable sized data blocks constituting a sensory observation. The system 102 may add one or more identifier bits to the sensory observation data block. The identifier bits may indicate for example whether the vehicle was under manual operation when the sensory observation was captured. Additionally, in some embodiments, the identifier bits may indicate a map data dependency status of the associated vehicle corresponding to the captured sensory observation. The map data dependency status may indicate whether navigation and/or control of the associated vehicle was performed with the aid of map data from the map database 104A. Additionally, in some embodiments, the identifier bits may also indicate if one or more vehicular functions of the associated vehicle are operated under manual or autonomous control when the sensory observations are captured. Thus, the identifier bits are essential indicators defining the context associated with the captured sensory observations.

To perform further processing on the generated vehicular observation data, in some embodiments, the system 102 may collect the vehicular observation data as one or more sensor datapoints corresponding to one or more vehicle functions. In some embodiments, each of the sensor datapoints comprises an autonomous functionality status identifier of the respective vehicle function of the one or more vehicle functions. That is, the autonomous functionality status identifier indicates whether a corresponding function is executed in manual mode or in autonomous mode. The autonomous functionality status identifier may have a binary value as either 1 or 0.

The system 102 may further filter each sensor datapoint into one of autonomous control data or manual control data to generate filtered data, based on the corresponding autonomous functionality status identifier of the respective sensor datapoint. In this regard the system 102 reads the autonomous functionality status identifier of the sensor datapoint. If the autonomous functionality status identifier is 1 the system 102 infers that the corresponding sensory observation is captured when the vehicle was under autonomous operational control. However, if the autonomous functionality status identifier is 0 the system 102 infers that the corresponding sensory observation is captured when the vehicle was under manual operational control. Accordingly, a datapoint is categorized as one of autonomous control data or manual control data. Repeating the filtering step for each datapoint yields filtered data comprising autonomous control dataset or manual control dataset.

According to some embodiments, the system 102 then executes a corresponding end-use application for further processing of the vehicular observations. For example, the autonomous control dataset may be used as a first training dataset for training a first machine learning model to optimize a performance of one or more vehicle functions provided by the OEM cloud. Alternately or additionally, the manual control dataset may be used as a second training dataset for training a second machine learning model to update the map database 104A. In some embodiments, the autonomous control dataset and/or the manual control dataset may be directly used for the corresponding application without requiring an ML model. For example, the autonomous control dataset and/or the manual control dataset may be directly processed by an application using or with the aid of heuristic algorithms, statistical analysis or manual review. Additionally, or alternately, in some embodiments, the system 102 may generate driver behavior data of a driver of a subject vehicle using the manual control dataset.

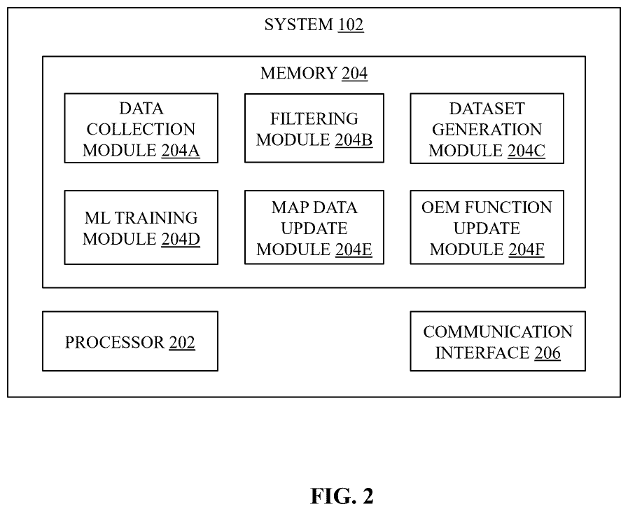

FIG. 2 illustrates a block diagram of the system 102 of FIG. 1, in accordance with one or more example embodiments. The system 102 may include at least one processor 202, a memory 204, and a communication interface 206. The memory 204 may be configured to store data, information, and software programs executable by the at least one processor 202 (hereinafter also referred to as processor). In this regard, the memory 204 may store various modules including a data collection module 204A, a filtering module 204B, a dataset generation module 204C, a ML training module 204D, a map data update module 204E, and an OEM function update module 204F. The processor 202 may fetch these modules from the memory 204 and execute them in any suitable order as desired.

In an embodiment, the vehicular observations may be received from the user equipment 106A and/or the user equipment 106B. Each of the user equipment 106A and the user equipment 106B may be a movable device coupled to a vehicle or be installed in the vehicle (such as the consumer or “probe” vehicle) or a robot, or may be a handheld device such as a smartphone. Alternately, in some embodiments each of the user equipment 106A and the user equipment 106B may be a stationary device mounted alongside roads, pathways, or across one or more structures in an area. Hereinafter, the description of some embodiments will be provided considering the user equipment to be installed in a vehicle, however, it may be contemplated that the operations of the system 102 may similarly be executed with other implementations of the user equipment that are described above. The vehicle may be equipped with one or more sensors such as a camera, an acceleration sensor (i.e., accelerometer), a gyroscopic sensor (i.e., gyroscope), a LiDAR sensor, a proximity sensor, a motion sensor, a positioning sensor (e.g., GNSS such as GPS), a wheel odometry, and the like. The sensors may detect sensor data associated with the object. Additionally, or alternatively, the sensors may determine vehicle's position and orientation. The user equipment 106A and/or the user equipment 106B may be configured to derive the vehicular observations using the sensor data and/or the vehicle's position and orientation.

The data collection module 204A collects the vehicular observations as one or more sensor datapoints corresponding to one or more vehicle functions. Where the system 102 is configured for generating the vehicular observation data, the data collection module 204A collects the one or more sensor datapoints by interfacing the system 102 with suitable sensors or data storages that capture and/or store the sensory measurements. For example, the data collection module 204A collects raw data from the vehicle's sensor suite. This suite typically includes an array of sensors such as LiDAR, radar, cameras, GPS, and other environmental sensors that capture a wide range of information. These sensors collect data about the vehicle's surroundings, such as road features, traffic signs, obstacles, and environmental conditions like weather or lighting and even from the vehicle's functions such as cruise control, steering, braking, headlight control, wiper control, HVAC control and so on. For example, the GPS sensor provides precise location data, while the camera and LiDAR sensors offer visual and depth information about the surrounding road objects. In embodiments where the system 102 is configured for processing the vehicular observation data, the data collection module 204A collects the sensor datapoints from a suitable memory storage or via a receiver that receives the vehicular observation data from a data capture system.

The filtering module 204B is executed when processing the vehicular observation data. In this regard, the system 102 may utilize the filtering module 204B to filter each sensor datapoint into one of autonomous control data or manual control data to generate filtered data, based on the corresponding autonomous functionality status identifier of the respective sensor datapoint. In this regard the system 102 reads the autonomous functionality status identifier of the sensor datapoint. If the autonomous functionality status identifier is 1 the system 102 infers that the corresponding sensory observation is captured when the vehicle was under autonomous operational control. However, if the autonomous functionality status identifier is 0 the system 102 infers that the corresponding sensory observation is captured when the vehicle was under manual operational control. Accordingly, a datapoint is categorized as one of autonomous control data or manual control data.

The system 102 utilizes the dataset generation module 204C to generate an autonomous control dataset and/or a manual control dataset. Towards this end, the dataset generation module 204C collects each categorized datapoint from the filtering module 204B and stores it in a corresponding memory buffer. When all the datapoints have been categorized, the module 204C outputs the autonomous control dataset and/or a manual control dataset.

This way, the system 102 provides capabilities for generating as well as segregating vehicular observation data into autonomous control data and manual control data which can be further utilized according to the desired end use application. In some embodiments, the system 102 may additionally or alternately be configured to train suitable machine learning models for tasks such as map data update or OEM function calibration. In such embodiments, the system 102 may invoke a ML training module 204D to train for example, a ML model for updating the map database 104A. In this regard, the ML training module 204D may utilize the manual control data to train the ML model. Additionally, or optionally, the ML training module 204D may train a ML model for optimizing the performance of one or more vehicular functions provided by a service provider such as the OEM cloud 108. In this regard, the ML training module 204D may utilize the autonomous control data to train the ML model. The ML training module 204D is designed to learn from the patterns and anomalies detected in this data, allowing the system to distinguish between normal variations in driving conditions and significant changes that warrant updates to the map database. For instance, when a vehicle encounters a new road or an updated intersection, the ML module 204D uses historical data and real-time inputs to accurately identify these changes, even in complex or ambiguous situations. This capability is essential for ensuring that the map data remains a true reflection of the actual road network, thereby enhancing navigation accuracy.

In some embodiments, the autonomous control dataset and/or the manual control dataset may be directly used for the corresponding application without requiring an ML model. In this regard, the system 102 may invoke a module for each such end use application. For example, the system 102 may invoke the map update module 204E to update the map database 104A or the OEM function update module 204F to optimize the performance of one or more vehicular functions provided by a service provider such as the OEM cloud 108. Towards these ends, the system 102 may suitably utilize one or more heuristic algorithms, statistical analysis approaches or manual review of the corresponding dataset (manual or automatic) for the corresponding end use application (map update or vehicular function optimization).

The at least one processor 202 may be embodied in a number of different ways. For example, the at least one processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), a GPU (Graphics Processing Unit), an AI engine (Artificial Intelligence enabled processing engine), an Quantum processor, an FPGA (field programmable gate array), a microcontroller unit (MCU), a hardware accelerator, a special-purpose computer chip, or the like. As such, in some embodiments, the at least one processor 202 may include one or more processing cores configured to perform independently. A multi-core processor may enable multiprocessing within a single physical package. Additionally, or alternatively, the at least one processor 202 may include one or more processors configured in tandem via the bus to enable independent execution of instructions, pipelining and/or multithreading.

Additionally, or alternatively, the at least one processor 202 may include one or more processors capable of processing large volumes of workloads and operations to provide support for big data analysis. In an example embodiment, the at least one processor 202 may be in communication with the memory 204 via a bus for passing information to the mapping platform 104. The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the at least one processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the at least one processor 202.

As exemplarily illustrated in FIG. 2, the memory 204 may be configured to store instructions for execution by the at least one processor 202. As such, whether configured by hardware or software methods, or by a combination thereof, the at least one processor 202 may represent an entity (for example, physically embodied in circuitry) capable of performing operations according to an embodiment of the present disclosure while configured accordingly. Thus, for example, when the at least one processor 202 is embodied as an ASIC, FPGA or the like, the at least one processor 202 may be specifically configured hardware for conducting the operations described herein. Alternatively, as another example, when the at least one processor 202 is embodied as an executor of software instructions, the instructions may specifically configure the at least one processor 202 to perform the algorithms and/or operations described herein when the instructions are executed. However, in some cases, the at least one processor 202 may be a processor specific device (for example, a mobile terminal or a fixed computing device) configured to employ an embodiment of the present disclosure by further configuration of the at least one processor 202 by instructions for performing the algorithms and/or operations described herein. The at least one processor 201 may include, among other things, a clock, an arithmetic logic unit (ALU) and logic gates configured to support operation of the processor 202.

In some embodiments, the at least one processor 202 may be configured to provide Internet-of-Things (IoT) related capabilities to a user of the system 102, where the user may be a traveller, a driver of the vehicle and the like. In some embodiments, the user may be or correspond to an autonomous or semi-autonomous vehicle. The IoT related capabilities may in turn be used to provide smart navigation solutions by providing real time updates to the user to take pro-active decision on lane maintenance, speed determination, lane-level speed determination, turn-maneuvers, lane changes, overtaking, merging and the like. The system 102 may be accessed using the communication interface 206. The communication interface 206 may provide an interface for accessing various features and data stored in the system 102. For example, the communication interface 206 may comprise I/O interface which may be in the form of a GUI, a touch interface, a voice enabled interface, a keypad, and the like. For example, the communication interface 206 may be a touch enabled interface of a navigation device installed in a vehicle, which may also display various navigation related data to the user of the vehicle. Such navigation related data may include information about upcoming conditions on a route, route display and alerts about lane maintenance, turn-maneuvers, vehicle speed, and the like.

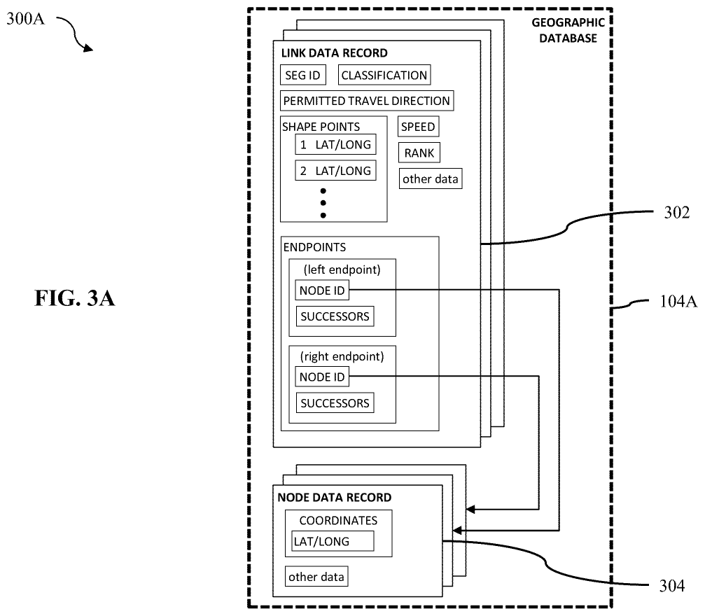

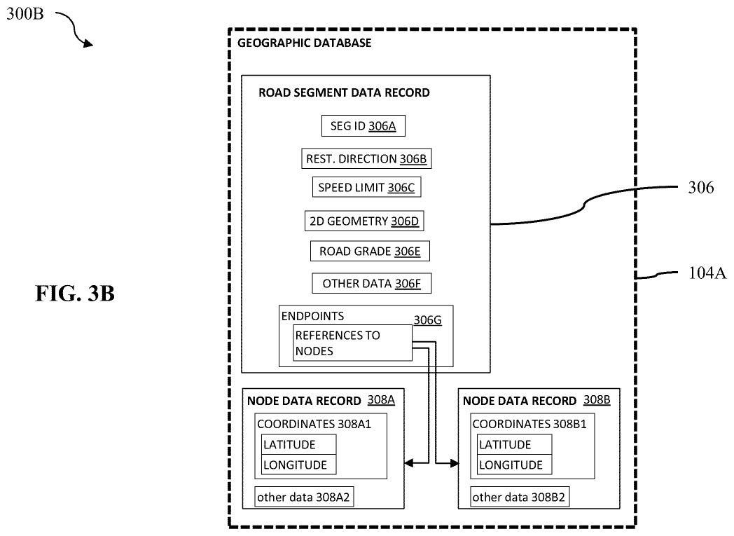

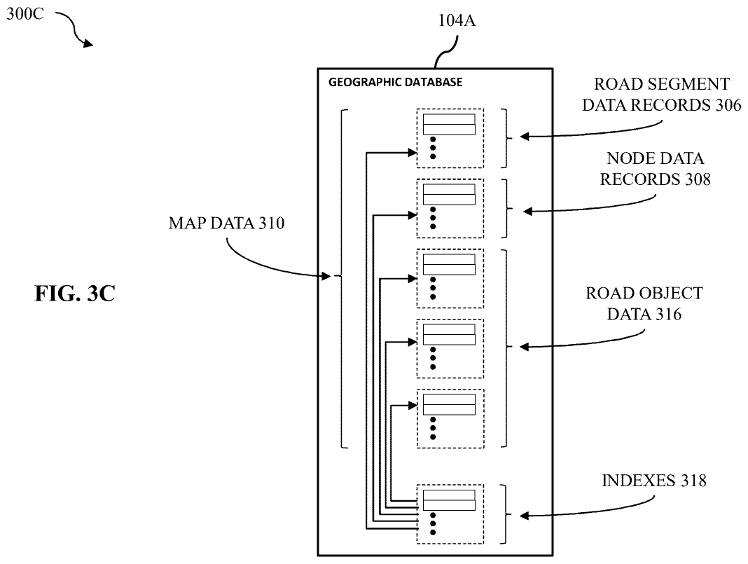

FIG. 3A illustrates a block diagram 300A showing a format of the map data stored in the map database 104A, in accordance with one or more example embodiments. The block diagram 300A includes a link data record 302 that may be used to store data about one or more of the road links. This link data record 302 has information (such as “attributes”, “fields”, etc.) associated with it that allows identification of the nodes associated with the road link and/or the geographic positions (e.g., the latitude and longitude coordinates and/or altitude or elevation) of the two nodes. In addition, the link data record 302 may have information (e.g., more “attributes”, “fields”, etc.) associated with it that specify the permitted speed of travel on the portion of the road represented by the link data record 302, the direction of travel permitted on the road portion represented by the link data record 302, what, if any, turn restrictions exist at each of the nodes which correspond to intersections at the ends of the road portion represented by the link record, the street address ranges of the roadway portion represented by the link record, the name of the road, and so on. The various attributes associated with a link may be included in a single data record or are included in more than one type of record which are referenced to each other.

Each link data record 302 that represents an other-than-straight road segment may include shape point data. A shape point is a location along a link between its endpoints. To represent the shape of other-than-straight roads, the mapping platform 104 and its associated map database developer selects one or more shape points along the other-than-straight road portion. Shape point data included in the link data record 302 indicate the position, (e.g., latitude, longitude, and optionally, altitude or elevation) of the selected shape points along the represented road link.

Additionally, in the compiled geographic database, such as a copy of the map database 104A that is compiled and provided to the user, there may also be a node data record 304 for each node. The node data record 304 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases are organized to facilitate the performance of various navigation-related functions. One way to facilitate performance of navigation-related functions is to provide separate collections or subsets of the geographic data for use by specific navigation-related functions. Each such separate collection includes the data and attributes needed for performing the particular associated function but excludes data and attributes that are not needed for performing the function. Thus, the map data may be alternately stored in a format suitable for performing types of navigation functions, and further may be provided on-demand, depending on the type of navigation function.

FIG. 3B illustrates a block diagram 300B showing another format of the map data stored in the map database 104A, in accordance with one or more example embodiments. As shown in the block diagram 300B, the map data in the map database 104A is stored by specifying a road segment data record 306. The road segment data record 306 is configured to represent data that represents a road network. Further, the map database 104A contains at least one road segment data record 306 (also referred to as “entity” or “entry”) for each road segment in a geographic region.

The map database 104A that represents the geographic region also includes a database record (or “entity” or “entry”) for each node associated with the at least one road segment shown by the road segment data record 306. The terms “nodes” and “segments” represent only one terminology for describing these physical geographic features and other terminology for describing these features is intended to be encompassed within the scope of these concepts. Each of the node data records 308A and 308B may have associated information (such as “attributes”, “fields”, etc.) that allows identification of the road segment(s) that connect to it and/or its geographic position (e.g., its latitude and longitude coordinates).

FIG. 3B also illustrates some of the components of the road segment data record 306 contained in the map database 104A. The road segment data record 306 includes a segment ID 306A by which the data record can be identified in the map database 104A. Each road segment data record 306 has associated with it information (such as “attributes”, “fields”, etc.) that describes features of the represented road segment. The road segment data record 306 may include data 306B that indicate the restrictions, if any, on the direction of vehicular travel permitted on the represented road segment. The road segment data record 306 includes data 306C that indicate a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day or weather. The static speed limit is the sign posted explicit speed limit for the road segment, or the non-sign posted implicit general speed limit based on legislation.

The road segment data record 306 may also include data 306D indicating the two-dimensional (“2D”) geometry or shape of the road segment. If a road segment is straight, its shape can be represented by identifying its endpoints or nodes. However, if a road segment is other-than-straight, additional information is required to indicate the shape of the road. One way to represent the shape of an other-than-straight road segment is to use shape points. Shape points are points through which a road segment passes between its end points. By providing the latitude and longitude coordinates of one or more shape points, the shape of an other-than-straight road segment can be represented. Another way of representing other-than-straight road segment is with mathematical expressions, such as polynomial splines.

The road segment data record 306 also includes road grade data 306E that indicate the grade or slope of the road segment. In one embodiment, the road grade data 306E include road grade change points and a corresponding percentage of grade change. Additionally, the road grade data 306E may include the corresponding percentage of grade change for both directions of a bi-directional road segment. The location of the road grade change point is represented as a position along the road segment, such as thirty feet from the end or node of the road segment. For example, the road segment may have an initial road grade associated with its beginning node. The road grade change point indicates the position on the road segment wherein the road grade or slope changes, and percentage of grade change indicates a percentage increase or decrease of the grade or slope. Each road segment may have several grade change points depending on the geometry of the road segment. In another embodiment, the road grade data 306E includes the road grade change points and an actual road grade value for the portion of the road segment after the road grade change point until the next road grade change point or end node. In a further embodiment, the road grade data 306E includes elevation data at the road grade change points and nodes. In an alternative embodiment, the road grade data 306E is an elevation model which may be used to determine the slope of the road segment.

The road segment data record 306 may also include other data 306F that refer to various other attributes of the road segment. The other data 306F may be included in a single road segment record or may be included in more than one type of record which cross-reference each other. The road segment data record 306 may also include data 306G providing the geographic coordinates (e.g., the latitude and longitude) of the end points of the represented road segment. In one embodiment, the data 306G are references to the node data records 308A and 308B that represent the nodes corresponding to the end points of the represented road segment.

The block diagram 300B also shows some of the components of the node data records 308A and 308B contained in the map database 104A. Each of the node data records 308A and 308B may have associated information (such as “attributes”, “fields”, etc.) that allows identification of the road segment(s) that connect to it and/or it's geographic position (e.g., its latitude and longitude coordinates). For instance, the node data records 308A and 308B include the latitude and longitude coordinates 308A1 and 308B1 for their nodes. The node data records 308A and 308B may also include other data 308A2 and 308B2 that refer to various other attributes of the nodes.

Thus, the overall data stored in the map database 104A may be organized in the form of different layers for greater detail, clarity, and precision. Specifically, in the case of high-definition maps, the map data may be organized, stored, sorted, and accessed in the form of three or more layers. These layers may include road level layer, lane level layer and localization layer. The data stored in the map database 104A in the formats shown in FIG. 3A and FIG. 3B may be combined in a suitable manner to provide these three or more layers of information. In some embodiments, there may be lesser or fewer number of layers of data also possible, without deviating from the scope of the present disclosure.

FIG. 3C illustrates a block diagram 300C of the map database 104A storing map data 310 in the form of road segments/links, nodes, and one or more associated attributes as discussed above. Furthermore, attributes may refer to features or data layers associated with the link-node database, such as an HD lane data layer.

In addition, the map data 310 may also include road object data 312. The road object data 312 may represent the one or more road objects. As used herein, the one or more road objects may correspond to road obstacles, traffic objects, posted signs (e.g., road signs), lane markings, road edges, and/or the like. These one or more road objects may be associated with the road segments represented by the road segment data records 306 or may be associated with the nodes represented by the node data records 308. The road object data 312 may include data related to the one or more road objects. The data related to the one or more road objects may include road object type information of the one or more road objects, location information of the one or more road objects, map identity information of the one or more road objects, and/or the like. Additionally, or alternatively, the road object data 312 may include the ground truth data associated with the one or more road objects. The ground truth data may include the map statuses of the one or more road objects. For instance, a map status of a road object of the one or more road objects may indicate a present state for the road object when the road object is present on the road segment represented by the road segment data records 306.

Additionally, the map database 104A may include indexes 314. The indexes 314 may include various types of indexes that relate the different types of data to each other or that relate to other aspects of the data contained in the geographic database 104A.

Some embodiments are based on the realization that the map data 310 stored in the map database 104A may be used to provide precise data for high-definition mapping applications, autonomous vehicle navigation and guidance, cruise control using ADAS, direction control using accurate vehicle maneuvering and other such services. Therefore, it is crucial for the map data 310 to accurately correspond with the real-world environments of the navigation vehicles. However, navigation features, such as the road objects, associated with the road segments may change over time and/or due to developments, such as the construction of new road segments. To address these situations, the system 102 is provided to update the map data 310 by processing the road object observations associated with the road objects.

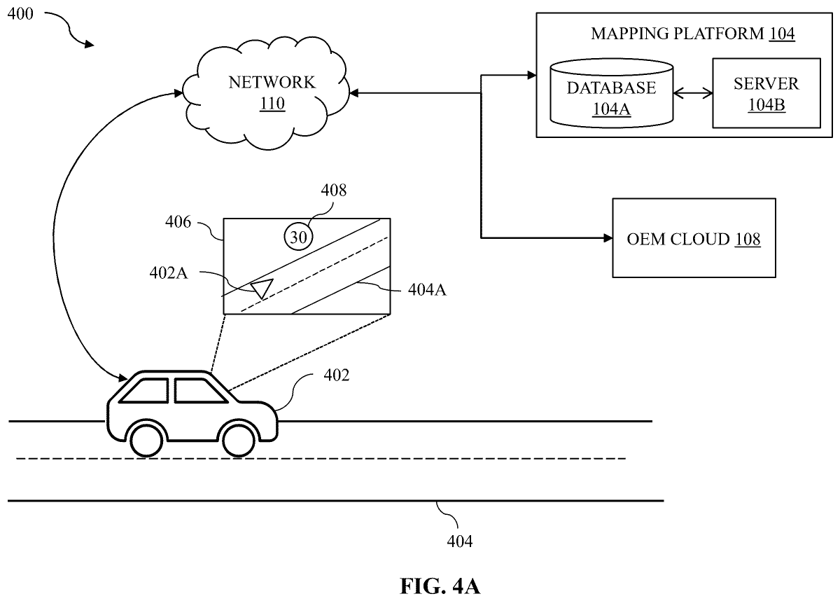

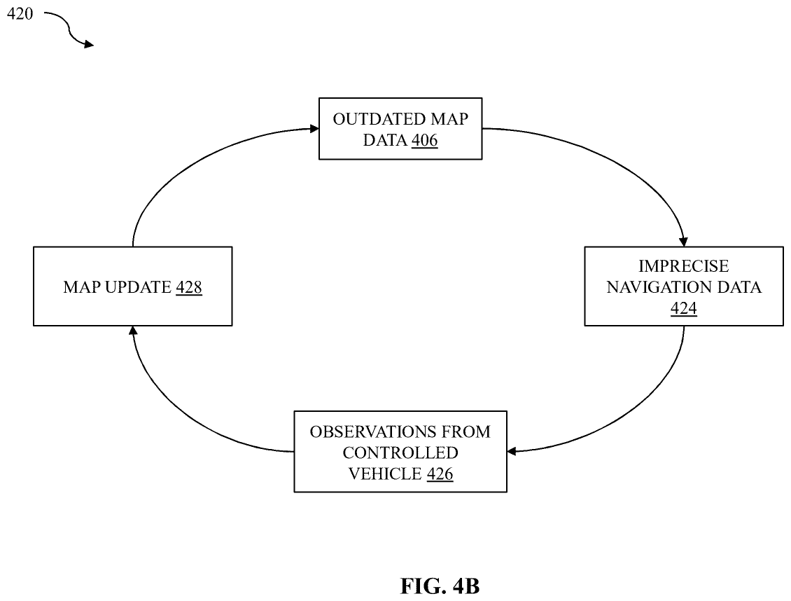

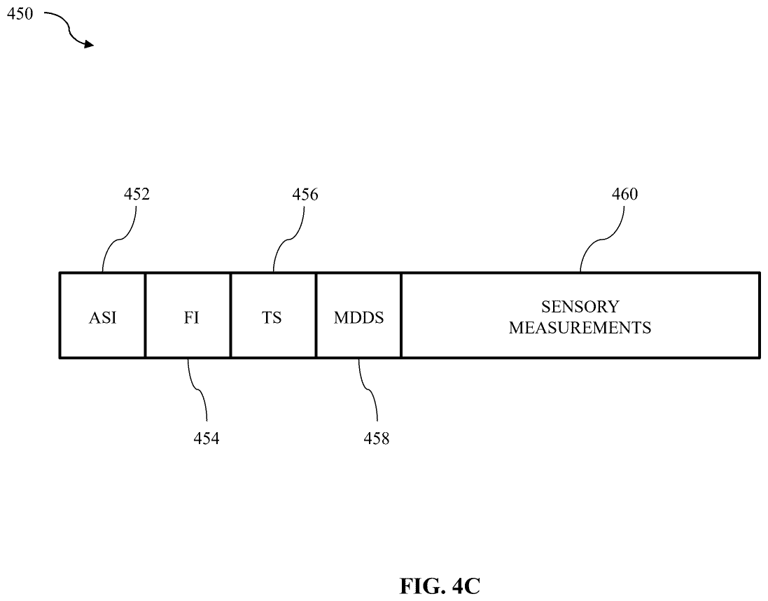

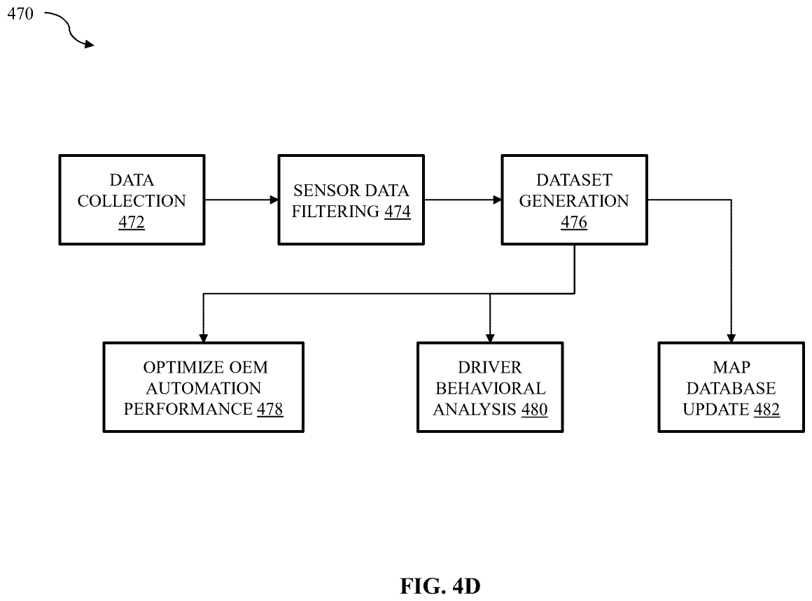

FIG. 4A illustrates a terrestrial data capture system 400A for processing vehicular observations. A vehicle 402 may be plying on a road 404 in a geographic area. The vehicle 402 may be equipped with a plurality of sensors for gathering data related to its surroundings including but not limited to the road 404, structures around the road 404, one or more timestamps, location data of the vehicle 402, and the like. The vehicle 402 may be communicatively coupled to the mapping platform 104 via the OEM cloud 108 which in turn is coupled to the vehicle 402 via the network 110. The vehicle 402 may access the map database 104A of the mapping platform 104 to perform navigation. In this regard, a map of the geographic area in which the vehicle 402 is plying is made available to the vehicle 402 as map data 406. The map data 406 may be rendered on a rendering device such that the map data 406 shows a digital replica 402A of the vehicle 402, a digital representation 404A of the road 404. Thus, the vehicle 402 moves under the navigation guidance derived from the contents of the map data 406. It may be considered that the vehicle 402 is moving under autonomous control and therefore all navigation controls are directly derived from the map data 406 provided by the mapping platform.

Under such operations, the vehicle 402 may perform data capture of the surroundings and send them as vehicular observations to the mapping platform 104 for further processing. The map data 406 shows a speed sign 408 alongside the road 404A in the rendered version of the map data 406. Accordingly, the autonomous control of the vehicle 402 may regulate the speed of the vehicle 402 to comply with the speed sign 408. However, it may be considered that in the real-world such a speed sign is absent. Therefore, the vehicular observation provided by the vehicle 402 to the mapping platform 104 may report a faulty speed at the segment where the faulty speed sign 408 is shown.

If the mapping server 104B processes such a faulty vehicular observation and updates the map database 104A to reflect the faulty speed indication, the map data 406 is never updated to reflect the correct status of the speed sign 408. This leads to a circular feedback loop 400B shown in FIG. 4B whereby the outdated map data 406 leads to imprecise navigation data 424 generated for the vehicle 402. Under control of the imprecise navigation data 424, the observations 426 from the controlled vehicle (such as the vehicle 402) are also faulty (i.e. they indicate false representation of road objects). As such, the map update 428 performed using such faulty observations 426 will lead to incorrect recording of ground truth in the map data 406 which still remains outdated. The loop 406-424-426-428-406 continues and leads to degradation in the quality of the map content. Therefore, conventional terrestrial data capture systems are ill equipped for critical end use tasks such as map making. It may be contemplated that a similar situation arises when vehicular functions are calibrated by OEMs using vehicular observations lacking contextual meaning.

To address the aforementioned issues arising out of conventional data capture systems, various example embodiments described herein provide measures to record information about which vehicle functions are under human control at any given time and, when automation is in use, whether the control system is heuristic or dependent on map content.

FIG. 4C illustrates an exemplary format of vehicular observation data 400C generated by the system of FIG. 2, in accordance with one or more example embodiments. The vehicular observation data 400C comprises an autonomous status identifier (ASI) field 452, a functionality identifier (FI) field 454, a timestamp field 456, a map data dependency status (MDDS) field 458, and sensory measurement fields 460. The system 102 encapsulates the sensory measurements provided by suitable sensors or other data gatherers along with information indicating whether the vehicle or one or more functions of the vehicle were under autonomous control or manual control, information indicating which functions were executed under autonomous mode, the timestamps associated with such sensory measurements, and information indicating whether map data was relied upon during the capture of sensory measurement. Each such information is recorded in the corresponding field of the vehicular observation data.

For example, the ASI field 452 may record a binary value of 1 or 0 with 1 indicating that the vehicle is under autonomous control and 0 indicating that the vehicle is under manual control. As used herein, autonomous control of the vehicle may refer to the scenario wherein driving, maneuvers, or any functionality of the vehicle are fully under automation mode while manual control of the vehicle may refer to the scenario wherein driving, maneuvers, or any functionality of the vehicle are fully under manual mode.

The FI field 454 may record one or more identifiers corresponding to the one or more functions of the vehicle that are under execution when the sensory measurements 460 is recorded. The TS filed 456 may record the timestamps associated with the sensory measurements 460. The MDDS field 458 may record a binary value of 1 or 0 with 1 indicating that the vehicle's operation is assisted by map data and 0 indicating that the vehicle's operation is not assisted by map data.

The system 102 generates the vehicular observation data 400C in the format as shown and described with reference to FIG. 4C which is then utilized for further processing.

FIG. 4D illustrates an exemplar framework 400D for processing the vehicular observation data 400C of FIG. 4C, in accordance with one or more example embodiments. The framework 400D comprises data collection at block 472, sensor data filtering at block 474, and dataset generation at block 476. Additionally, the framework 400D may further comprise optimization of OEM automation performance 478, driver behavioral analysis 480, and map database update 482. The framework is designed to efficiently manage and utilize the vast amounts of sensor data collected by autonomous vehicles for both performance enhancement and ensuring up-to-date navigational maps.

At block 472 of the data processing framework 400D, sensor data pertaining to vehicular observations is collected from various sources such as on-board sensors integrated into the vehicle or from external data capturing systems such as traffic cameras, road side units etc. The on-board sensors may include, but are not limited to, cameras, LiDAR, radar, GPS, and environmental sensors such as temperature, humidity, and light intensity sensors. The sensors may also include ambient light sensors, rain sensors, impulse sensors and many more. In some embodiments, data could also be collected from external sources, including vehicle-to-vehicle (V2V) communications or vehicle-to-infrastructure (V2I) systems, thereby providing a more comprehensive view of the driving environment. For example, a vehicle may collect data on surrounding traffic, road conditions, and nearby obstacles during its operation, whether it is under autonomous control or manual control by a driver.

Following data collection, at block 474, the sensor data undergoes filtering at block 474 to categorize it based on the control mode (autonomous or manual) under which it was collected. As discussed previously, the ASI field of the vehicular observation data may be read to discern the corresponding control mode. This data filtering step is crucial as it ensures that only the relevant data is utilized in subsequent processing steps. For instance, data collected while the vehicle is autonomously navigating through a city center may be categorized separately from data collected during a manual parking maneuver. In some embodiments, this filtering process may also accommodate hybrid scenarios where both autonomous and manual controls are applied, ensuring that the resulting datasets are comprehensive and reflective of real-world driving conditions. This step might involve real-time filtering of the data, allowing for immediate categorization and storage, which is particularly useful in rapidly changing driving environments. The data filtering step filters the data as whether the vehicle is moving in autonomous mode or manual mode by using autonomous functionality identifier. For the sake of clarity, manual operation or manual control is discerned only when the ASI field indicates there was no autonomous control active for the driving and maneuvering of the vehicle.

At block 476, the filtered data is used to generate two distinct datasets. The first dataset corresponds to autonomous control data, which is crucial for training machine learning models aimed at enhancing autonomous driving performance. For example, data from successful autonomous lane changes, obstacle avoidance, or emergency braking scenarios may be included in this dataset. The second dataset corresponds to manual control data and is used to train models that update the map database. In some embodiments, this might involve data from manual navigation through areas not yet covered by existing maps or where the current maps have become outdated due to recent construction or road modifications. Additionally, this step may include generating datasets that account for extreme driving conditions, such as icy roads or heavy fog, ensuring that the vehicle's autonomous system can handle a wide range of scenarios. According to some embodiments, the datasets generated at block 476 may directly be used for the respective end-use application, without requiring or encompassing model training as an intermediate step. For example, any suitable heuristic algorithm, statistical analysis or manual review-based approach of the corresponding dataset may be used for the respective end use application.

At block 478, the first dataset corresponding to autonomous control data may be used for optimizing the performance of one or more functions provided by the OEM of the vehicle. Such functions may include both driving related functions such as lane assist, cruise control as well as non-driving related functions for the vehicle such as wiper control, headlight control, HVAC control etc. The autonomous control data corresponds to the observations recorded when one or more functionalities in the vehicle were executed in autonomous mode. The functions that were executed in autonomous mode can be identified by reading values in the FI field of the vehicular observation data. In this way, all the sensory measurements corresponding to a particular function may be fetched using the function identifier of the function. These sensory measurements may be correlated with benchmarked results to evaluate the performance of the functions under autonomous mode. This may include refining algorithms responsible for adaptive cruise control, lane keeping, or collision avoidance. For example, a model may be trained to improve the vehicle's response time in emergency situations or to enhance its ability to navigate through complex urban environments with high traffic density. In some embodiments, the optimization may also extend to predictive maintenance, where the model identifies potential vehicle issues before they lead to system failures, based on the patterns observed in the sensor data.

At block 480 driver behavioral analysis may be performed using the manual control data. In some embodiments, the ASI field may have a zero only when the driving and/or maneuver controls are under manual operation. In such embodiments, there may be a separate ASI field for each FI field indicating which functions were under what kind of control. With such a configuration, the vehicular observation data is highly granular providing autonomous status for almost every function in the vehicle. The driver behavioral analysis may be performed to discern how driving patterns evolve with increased level of automated functionalities. In this regard, a mobility profile may be generated for each driver, each road segment, or even each automated functionality.

At block 482, the map database may be updated either using model-based approaches or directly using comparative approaches. For example, the model trained on the manual control dataset may be employed to update the map database. This model ensures that the vehicle's navigation system is equipped with the most current geographical data, essential for accurate route planning and navigation. For instance, if the vehicle encounters a newly constructed road or a recently added traffic signal, this information may be processed and integrated into the map database. In various embodiments, the map update process may also include data on temporary changes, such as detours or temporary road closures, ensuring that the vehicle's navigation system can provide accurate and timely directions.

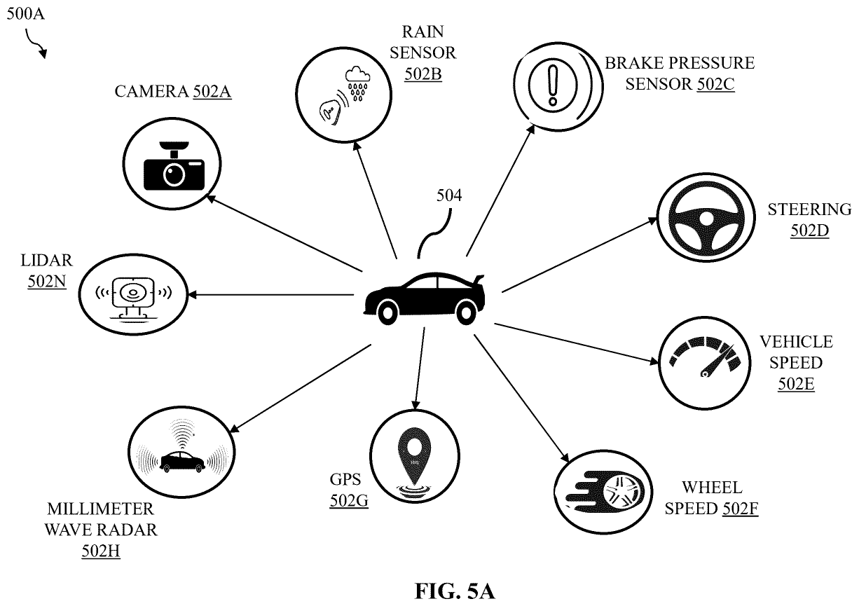

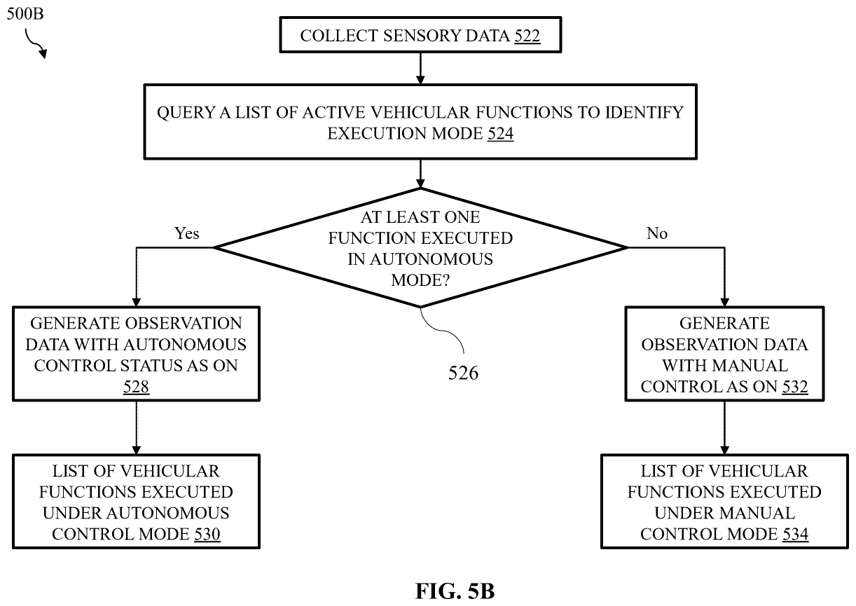

FIG. 5A illustrates a system architecture 500A for collecting sensor data from various sensors. As illustrated in FIG. 5A, the system architecture 500A includes a plurality of sensors, such as one or more cameras 502A, rain sensors 502B, brake pressure sensors 502C, steering sensors 502D, vehicle speed sensors 502E, wheel speed sensors 502F, GPS 502G, millimeter wave radars 502H, and LiDARs 502I. Each sensor of the plurality of sensors is strategically positioned within or around the vehicle 504 to collect specific data that is crucial for both manual and autonomous driving functionalities.

In various embodiments, the plurality of sensors may report their respective sensory data to the system 102, which processes the data for various applications such as real-time decision-making, training machine learning (ML) models, and updating a map database. For example, the cameras 502A may capture visual data including images and videos, which can be used by the system 102 to detect and recognize road signs, traffic lights, and obstacles. Similarly, the rain sensors 502B may detect environmental conditions like rain, providing data that could prompt the vehicle 504 to adjust its speed or activate the windshield wipers automatically. The brake pressure sensors 502C may monitor the brake system's pressure, allowing the system 102 to assess the braking force applied during manual or autonomous driving, which can then be used to optimize braking performance. In some embodiments, each piece of sensory data derived from the plurality of sensors may include specific metadata such as time-stamp data, location information, sensor status, and environmental conditions. For example, the data from the Wheel Speed Sensor 502F, which monitors the rotational speed of each wheel, may include time-stamped information that can be used to assess traction levels on various road surfaces.

FIG. 5B illustrates a flowchart 500B describing data filtering for segregating vehicular observations, in accordance with one or more example embodiments. The sensory data generated by various sensors may be collected 522 by the system 102. A key aspect of the data collection process is that it records not only the sensor observations but also the status of vehicle control functions specifically, whether these functions are under human control, heuristic automation, or map content-dependent automation. For instance, if during data collection, the vehicle's steering and acceleration are automated based on map data, this information is logged along with the sensory data.

A list of active vehicular functions may be queried 524 to identify the execution mode of each active function. In this regard, the system 102 may check if automation is active for execution of a particular function or not. This may be determined for example by checking if one or more input ports corresponding to user operated ports such as UIs, switches, etc is actively desired for execution of a vehicular function. Accordingly, for every vehicular function, it may be determined whether the function is executed in autonomous or manual mode. This check is determined at step 526 of the flowchart 500B. If at 526, at least one function is found to be executed in autonomous mode, the control passes to step 528 otherwise the control of steps passes to step 532.

At step 528, observation data with ASI field having 1 (i.e. autonomous ON) is generated. The observation data generated at this step includes all sensory measurements captured when autonomous control mode was on for the vehicle. Accordingly, based on the accumulated observation data at step 528, a list of vehicular functions that are executed under autonomous control mode may also be derived at step 530. Such a list can be queried using the function identifier of the vehicular functions.

If the outcome of the check at step 526 is no, then the flowchart proceeds to step 532 where observation data with ASI field having 0 (i.e. autonomous OFF) is generated. The observation data generated at this step includes all sensory measurements captured when manual control mode was on for the vehicle. Accordingly, based on the accumulated observation data at step 532, a list of vehicular functions that are executed under manual control mode may also be derived at step 534. Such a list can be queried using the function identifier of the vehicular functions.

The process illustrated in FIG. 5B directly supports the invention's goal of improving map-making processes and enhancing automation quality by providing a clear distinction between different modes of vehicle operation. For example, a map-making system can use the categorized data to understand where human drivers tend to stop or change lanes, as opposed to where the automation system does. This distinction is crucial for building accurate behavior-based maps, which aggregates data on maneuvers, speed profiles, and lane transitions under various conditions.

Furthermore, by logging when and where different types of automation were in use, the system enables OEMs to continuously monitor and improve their automation systems. For example, if a specific route shows a high frequency of manual overrides, this could indicate that the automation system's performance is suboptimal under certain conditions, necessitating further refinement. Conversely, if the automation system performs consistently well compared to human drivers, this data can be used to justify broader deployment or reduced human intervention.

The data filtering and classification process depicted in FIG. 5B is central to the invention's capability to distinguish between different operational modes, thereby providing valuable insights for both map-making and automation improvement. By including the status of vehicle control functions alongside sensor data, the invention ensures that the data used in downstream applications is both accurate and contextually relevant, ultimately leading to safer and more reliable autonomous driving systems.

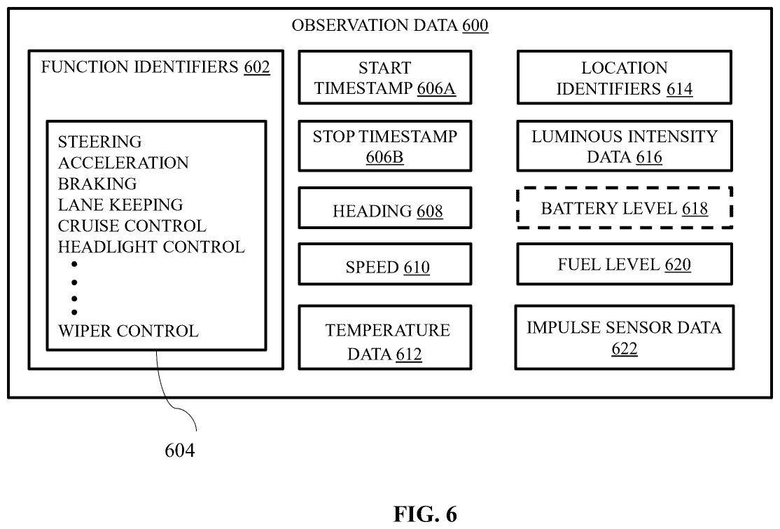

FIG. 6 illustrates an exemplary structure of vehicular observation datasets 600 (also referred to as observation data 600) used in accordance with one or more example embodiments. The observation data 600 comprises various segments for indicating and recording a corresponding data field or type. The observation data 600 may include data regarding vehicle dynamics, environmental conditions, and positional information of the vehicle. For example, the observation data 600 may include one or more function identifiers 602 corresponding to one or more vehicular functions 604. According to some embodiments, although not shown in FIG. 6, each function identifier 602 may have a corresponding autonomous status identifier (ASI) field for indicating whether the corresponding vehicular function was executed in autonomous or manual mode.

The observation data 600 may also include a start timestamp 606A indicating the commencement of one or more events associated with capture of the observation data 600. Similarly, the observation data 600 may also include a stop timestamp 606B indicating the ending of one or more events associated with capture of the observation data 600. Other datapoints such as heading 608 of the vehicle, speed 610 of the vehicle, temperature data 612 associated with the vehicle, location identifiers 614 of the vehicle may also be included in the observation data 600. According to some embodiments, the observation data 600 may also include luminous intensity data 616 captured by illumination sensors of the vehicle, battery level 618 of the battery of the vehicle, fuel level 620 of the vehicle, and impulse sensor data 622 for the vehicle.

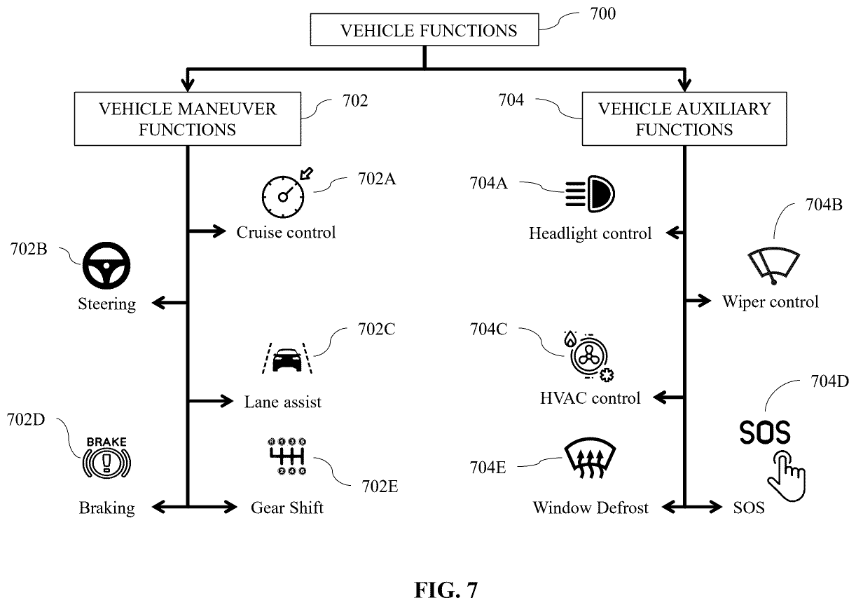

FIG. 7 illustrates some exemplary vehicular functions 700 in accordance with one or more example embodiments. The vehicle functions 700 may be categorized into two distinct classes: vehicle maneuver functions 702 and vehicle auxiliary functions 704. This diagram is pivotal to understanding the invention's approach to managing and optimizing various vehicle operations, whether they pertain to the core driving maneuvers or the auxiliary systems that support overall vehicle functionality. Each of these classes contains several specific functions, each of which can operate under either autonomous or manual control.

The first category, vehicle maneuver functions 702, may include critical driving operations such as cruise control 702A, steering 702B, lane assist 702C, braking 702D, and gear shift functions 702E using stick shift and clutch, paddle shifters, or automatic transmission. These functions are essential to the vehicle's navigation and control, determining how the vehicle accelerates, decelerates, steers, and maintains its position within a lane on the road. The sensors associated with these functions such as steering angle sensors, speed sensors, and lane detection cameras provide continuous data that is crucial for both autonomous driving systems and manual driving assessments.

For example, the cruise control function 702A can be set to maintain a constant speed, reducing driver fatigue on long trips. However, the system also captures data on how this function is managed whether the driver is overriding it or if the system is adjusting to dynamic road conditions such as changes in terrain or the presence of other vehicles. Similarly, the steering function 702B, which involves the real-time management of the vehicle's direction, is another key aspect where data is collected. Whether this function is under human control or managed autonomously, the system captures the associated data, including steering angles, force applied, and reaction times, all of which are critical for training machine learning models aimed at optimizing vehicle handling and safety.

The lane assist function 702C and braking function 702D also provide significant data. Braking data includes information about the pressure applied, the timing of brake application, and the vehicle's deceleration rate. This data is invaluable for understanding the nuances of driver behavior and for improving the autonomous braking systems that are designed to react faster and more effectively than a human could in emergency situations. Lane assist 702C, on the other hand, involves maintaining the vehicle within a lane through subtle steering adjustments. Data from this function, including deviations from the lane centre and the frequency of driver overrides, helps in refining the algorithms that control lane-keeping assistance systems, thereby improving safety and comfort during driving. The gear shift function 702E may perform gear shifting in response to control inputs or commands. In this regard, the gear shift may be executed via stick shift and clutch, paddle shifters, or automatic transmission.

The second category, vehicle auxiliary functions 704, includes functions that support the overall driving experience but are not directly related to the vehicle's movement. These auxiliary functions include headlight control 704A, wiper control 704B, HVAC (heating, ventilation, and air conditioning) control 704C, the SOS function 704D, and window defrost function 704E. Each of these functions also generates critical data that contributes to the invention's goal of optimizing vehicle systems through machine learning, heuristic, or statistical approaches.

For instance, the headlight control function 704A may involve automatic adjustments based on ambient light levels or oncoming traffic, ensuring optimal visibility for the driver while avoiding glare for other road users. The data collected from this function includes light intensity, timing, and the conditions under which the headlights were activated or dimmed. Similarly, wiper control 704B adjusts the windshield wipers based on the detected level of precipitation. This function gathers data on wiper speed, frequency, and activation times, which can be used to improve automatic wiper systems that respond to changing weather conditions.

The HVAC control function 704C is responsible for maintaining the cabin's temperature and air quality. It collects data on temperature settings, fan speeds, and air distribution patterns, which is essential for enhancing the vehicle's climate control systems. Finally, the SOS function 704D provides a crucial safety feature, allowing for immediate communication with emergency services in case of an accident or other emergency situations. Data from this function, such as activation times and response intervals, is key to improving the reliability and effectiveness of emergency response systems.

All these functions, both maneuver and auxiliary, are integral to the vehicle's operation and contribute to the data pool that the system collects and processes. This data is subsequently filtered and classified, as shown in previous diagrams, for respective end use applications. Although FIG. 7 provides select examples of functions of each category, it may be contemplated that several other types of functions may be included in each category within the scope of this disclosure. Additionally, several or fewer categories of functions may be possible than the ones shown in FIG. 7.

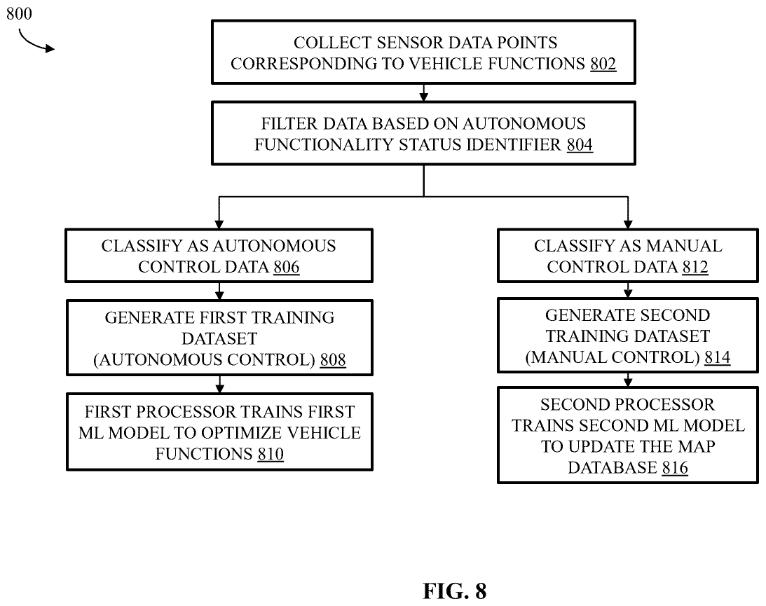

FIG. 8 illustrates a flowchart of a method 800 for processing vehicular observations, in accordance with one or more example embodiments. It will be understood that each block of the flow diagram of the method 800 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 204 of the system 102, employing an embodiment of the present invention and executed by the processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram 800 may support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

At step 802, the method 800 may include collecting sensor datapoints corresponding to the vehicle functions. In some embodiments, each of the sensor datapoints comprises an autonomous functionality status identifier of the respective vehicle function of the one or more vehicle functions. That is, the autonomous functionality status identifier indicates whether a corresponding function is executed in manual mode or in autonomous mode. The autonomous functionality status identifier may have a binary value as either 1 or 0.

At step 804, the method 800 comprises filtering each sensor datapoint into one of autonomous control data or manual control data to generate filtered data, based on the corresponding autonomous functionality status identifier of the respective sensor datapoint. In this regard the autonomous functionality status identifier of the sensor datapoint may be read. If the autonomous functionality status identifier is 1 it is inferred that the corresponding sensory observation is captured when the vehicle was under autonomous operational control. However, if the autonomous functionality status identifier is 0 it is inferred that the corresponding sensory observation is captured when the vehicle was under manual operational control. Accordingly, a datapoint is categorized as one of autonomous control data or manual control data. Repeating the filtering step for each datapoint yields filtered data comprising autonomous control dataset or manual control dataset. The output of step 804 leads to classification of the sensor datapoints as either autonomous control data at step 806 or as manual control data at step 812.

In some embodiments, the method 800 may further comprise executing one or more end use applications for further processing of the generated control data at steps 806 and 812. In this regard, in some embodiments, at step 808 the method 800 comprises generating a first training dataset based on the autonomous control data generated at step 806. The first training dataset may be used by a first processor for training 810 a first machine learning model to optimize a performance of one or more vehicle functions provided by the OEM cloud. At step 814, the method 800 comprises generating a second training dataset based on the manual control data generated at step 812. The second training dataset may be used by a second processor for training 816 a second machine learning model to update the map database.

Additionally, or alternatively, the method 800 may include a step of determining driver behaviour data of a driver of at least one vehicle, based on the second training dataset. Additionally, or alternatively, first training dataset excludes the manual control data, and the second training dataset excludes the autonomous control data. In some embodiments, each sensor datapoint of the one or more sensor datapoints further comprises a functionality identifier of a respective vehicle function of the one or more vehicle functions, one or more timestamps associated with the respective vehicle function of the one or more vehicle functions, and one or more location identifiers associated with the respective vehicle function of the one or more vehicle functions.

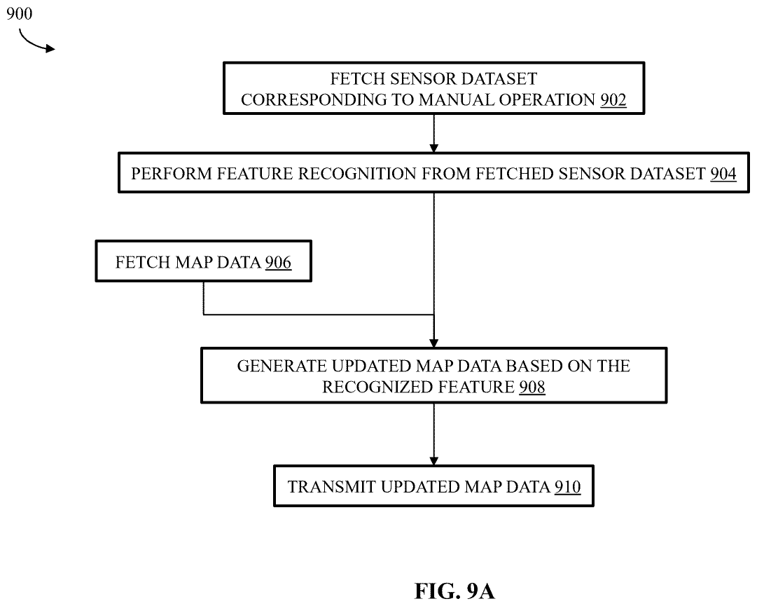

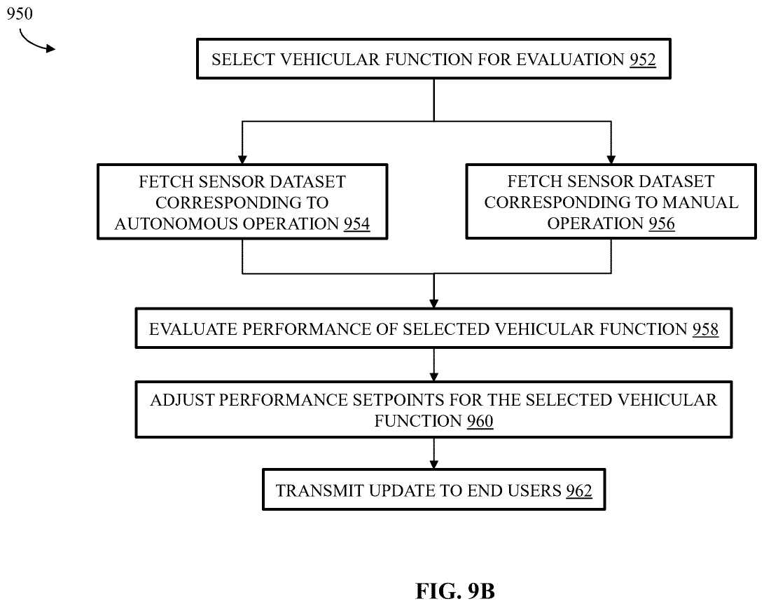

FIG. 9A illustrates a flowchart of a method 900 for updating map data using vehicular observation data, in accordance with one or more example embodiments. The method 900 may be executed by a suitable computing system such as the system 102. In this regard, the updating of map data may be carried out locally inside a vehicle that captures the vehicular observation data or remotely at a server or cloud. When the map update is performed locally within the vehicle, the updated map data may be transmitted to a master database for further processing. Referring to FIG. 9A, at step 902, the method 900 comprises fetching or retrieving sensor dataset corresponding to manual operation of the vehicle. In this regard, the manual control data output at step 812 of FIG. 8 may be retrieved for further processing. At step 904, the method 900 comprises performing feature recognition from the fetched sensor dataset. In this regard, any suitable feature recognition algorithm may be deployed to identify one or more map features from the fetched manual control data. At step 906, the map data may be retrieved, for example, from the map database 104A. In some embodiments, the map data may be available locally within a system executing the method 900. Using the map data and the feature recognized at step 904, the method 900 proceeds to step 908 where updated map data is generated to reflect the recognized feature if it is absent or differently represented in the map data. In this regard, any suitable map making algorithm may be utilized. The updated map data is then transmitted at step 910 for example to other users or the mapping platform 104.

FIG. 9B illustrates a flowchart of a method 900B for adjusting vehicular function quality using vehicular observation data, in accordance with one or more example embodiments. The method 900B may be performed by a suitable computing system such as the system 102. According to some embodiments, the method 900B may be carried out locally inside the vehicle that captures the vehicular observations or remotely at one or more OEMs providing the vehicular functionalities. Referring to FIG. 9B, at step 952, a candidate vehicular function is selected for evaluation. Each vehicular function executed in the vehicle may be identified as per a corresponding function identifier.

At step 954, the method 900B comprises fetching or retrieving sensor dataset corresponding to autonomous operation of the vehicle. In this regard, the autonomous control data output at step 806 of FIG. 8 may be retrieved for further processing. At step 956, the method 900B comprises fetching or retrieving sensor dataset corresponding to manual operation of the vehicle. In this regard, the manual control data output at step 812 of FIG. 8 may be retrieved for further processing. It may be noted that in either step, the function identifier of the candidate function may be used to query the data and only those data that are relevant to the candidate function may be retrieved.

At step 958, the method 900 comprises evaluating the performance of the candidate vehicular function selected at step 952. Towards this end, the sensory observations corresponding to when the candidate function was executed in the vehicle may be correlated with benchmarked data or reference data and the deviation between the two may serve as an indication for the performance quality. In some scenarios the reference data for evaluating the performance quality may be predetermined. In such scenarios, some embodiments may solely use the autonomous control data fetched at step 954 and compare it with the reference data to evaluate the performance quality. In some other scenarios the reference data for evaluating the performance quality may not be available beforehand. In such scenarios, both the autonomous control data fetched at step 954 and the manual control data fetched at step 956 may be utilized for evaluating the performance of the candidate function, whereby the manual control data may serve as the reference data.

The evaluation of the performance of the candidate vehicular function may be parameterized or quantified to indicate the quality. For example, the output of step 958 may return a quality score indicative of the performance quality of the vehicular function selected at step 952. If the quality score indicates requirement for improvement in the performance of the function, the method proceeds to step 960 where the performance setpoints for the selected vehicular function are adjusted. The objective for the adjustment may be to bring the performance of the function closer to the reference levels. The adjusted setpoints are translated into machine coded instructions which are then transmitted at step 962 as an update to end users such as vehicles.

Considering an example, the function of automated headlight control may be evaluated by comparing vehicular sensor data captured when the headlight control was fully automatic. It may be considered that a vehicular observation may indicate that at location coordinates between L1 and L2, and during the period defined between timestamps TS1 and TS2, the headlight was turned ON automatically. The vehicular observation data may also indicate that during the said time period, the ambient light sensor of the vehicle reported illumination intensity between IL1 and IL2. With such information provided, the corresponding OEM may compare the illumination intensities with reference intensity level IL_ref and conclude that although IL1 and IL2 were below IL_ref, the time period between TS1 and TS2 was shorter than a threshold period and hence, it should not have been counted as an incident where headlight was to be turned on. Accordingly, the OEM may tune parameters of the automated headlight control function to define the threshold time period as a control parameter for turning the headlights on. The reprogrammed algorithm may be coded into machine executable instructions and broadcasted to end use vehicles for upgrading the setpoints of the automated headlight control functionality.

The aforesaid examples for updating map data (FIG. 9A) and optimizing vehicular function performance (FIG. 9B) may also be carried out using machine learning models that may learn patterns using the dataset provided to them.

In this way, various embodiments provide frameworks particularly relevant in the context of modern autonomous and semi-autonomous vehicles, where the seamless integration of real-time data collection, classification, and processing plays a critical role in enhancing both the functionality and safety of the vehicle. Various embodiments involve collecting sensor data points corresponding to vehicle functions. The data collection process is further enhanced by the recording of which vehicle functions such as steering, acceleration, braking, shifting, headlights, and wipers are under human control at any given moment. Moreover, it is critical to record whether these control systems are operating under heuristic algorithms, are dependent on pre-existing map content, or are influenced by map content that has been derived from previous driver behavior. This comprehensive recording is essential because it allows the system to accurately categorize and later analyze the data, depending on the level of autonomy involved during data collection. For instance, a vehicle may operate under full human control, where all decisions are made by the driver, or it may function under various levels of automation, where some or all control is transferred to automated systems. Each of these scenarios presents a different context for the data, which must be carefully considered in the subsequent stages of data processing.

Various embodiments also involve filtering the data based on autonomous status identifier, where the collected data undergoes a filtering process based on an autonomous functionality status identifier. This filtering process is crucial as it differentiates data collected under various operating conditions. Specifically, it distinguishes between data collected when the vehicle was under human control, data gathered when heuristic automation was in use, and data collected when the vehicle was operating under automation that relies on map content derived from previous driver behavior. The filtering process, therefore, serves as a gatekeeper, ensuring that only relevant and contextually appropriate data moves forward in the processing pipeline.

Various embodiments also involve a classification phase to generate autonomous control data pertaining to data that was collected while the vehicle was predominantly under autonomous control. This category of data is particularly valuable for applications aimed at optimizing vehicle functions. For instance, the system might analyze how the autonomous control algorithms managed speed, navigation, and obstacle avoidance under various conditions. The classification also returns manual control data, which encompasses data collected during periods when the vehicle was operated manually by a human driver. This category of data is used in applications aimed at updating the map database. By analyzing this manually collected data, the system can gain insights into human driving behavior, which can be used to refine and enhance the accuracy of the map database. For example, data on common stopping locations, lane changes, and speed adjustments made by human drivers can be used to update and improve the map database, making it more reflective of real-world driving conditions.

Various embodiments directly address several critical use cases that are evident and apparent in the field of vehicular navigation and terrestrial data capture. For instance, the framework allows the system to distinguish between data collected from human-driven scenarios and those involving autonomous control. This distinction is particularly important in map-making processes, where understanding the context of the data is essential for creating accurate and reliable maps. Moreover, this framework enables Original Equipment Manufacturers (OEMs) to monitor and improve the quality of the performance of autonomous systems by providing a basis for comparing autonomous operations with human driving behavior. Additionally, the framework facilitates the monitoring of changes in driver behavior by isolating data collected under full human control, thereby allowing for targeted improvements in both manual and autonomous driving systems.

In various embodiments, the data collection, filtering, classification, and training processes can be implemented across multiple vehicles or centralized within a cloud-based system. This flexibility ensures that the invention can be adapted to different use cases and deployment environments, whether for in-vehicle systems, centralized data processing hubs, or a combination of both. The adaptability of this framework enhances its applicability across a wide range of scenarios, making it a robust and versatile solution for modern vehicle data processing and map database updating needs.

Therefore, in accordance with various embodiments of the present disclosure, the map data in a map database may be updated in an efficient manner such that the updated map data corresponds to a ‘true’ or ‘near true’ reflection of a dynamically changing real-world environment. Enabled with such an improved and updated map database, end use devices and systems such as navigation systems that utilize the map database for generating routing instructions benefit from the improved accuracy and are thus capable of generating accurate navigation control instructions. In this way, embodiments of the present disclosure provide measures and techniques to mitigate inaccuracies of navigation systems, thereby reducing potentially dangerous maneuvers that could otherwise have led to accidents or collisions of the vehicles utilizing the map data of the map database. Thus, several embodiments of the disclosure find applications in the real world while providing technical improvements in the field of mapping and navigation technology as well as vehicle safety.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A computer-implemented method, comprising:
collecting one or more sensor datapoints corresponding to one or more vehicle functions, wherein each sensor datapoint of the one or more sensor datapoints comprises an autonomous functionality status identifier of the respective vehicle function of the one or more vehicle functions;
filtering each sensor data point into one of autonomous control data or manual control data to generate filtered data, based on the corresponding autonomous functionality status identifier of the respective sensor data point; and
generating at least one of a first dataset or a second, based on the filtered data, wherein the first dataset corresponds to the autonomous control data, and wherein the second dataset corresponds to the manual control data.

2. The method of claim 1, further comprising controlling at least one of:
a first processor for training, using the first dataset, a first machine learning (ML) model to optimize a performance of the one or more vehicle functions; or
a second processor for training, using the second dataset, a second machine learning (ML) model to update a map database.

3. The method of claim 1, further comprising determining driver behavior data of a driver of at least one vehicle, based on the second dataset.

4. The method of claim 1, further comprising controlling at least one of:
a first processor to optimize a performance of the one or more vehicle functions, based on the first dataset, wherein the first processor utilizes one or more of first heuristic algorithms, first statistical analysis or first user inputs corresponding to manual review of the first dataset to optimize the performance of the one or more vehicle functions; or
a second processor to update a map database, based on the second dataset, wherein the second processor utilizes one or more of second heuristic algorithms, second statistical analysis or second user inputs corresponding to manual review of the second dataset to update the map database.

5. The method of claim 1, wherein each sensor datapoint of the one or more sensor datapoints further comprises a functionality identifier of a respective vehicle function of the one or more vehicle functions, one or more timestamps associated with the respective vehicle function of the one or more vehicle functions, and one or more location identifiers associated with the respective vehicle function of the one or more vehicle functions.

6. The method of claim 1, wherein the first dataset comprises a functionality identifier of at least one vehicle function of the one or more vehicle functions executed under autonomous mode, one or more timestamps corresponding to at least one of a start time of execution of the at least one vehicle function or an end time of execution of the at least one vehicle function, one or more location identifiers corresponding to at least one of the start time of execution of the at least one vehicle function or the end time of execution of the at least one vehicle function.

7. The method of claim 1, wherein the second dataset comprises a functionality identifier of at least one vehicle function of the one or more vehicle functions executed under manual mode, one or more timestamps corresponding to at least one of a start time of execution of the at least one vehicle function or an end time of execution of the at least one vehicle function, one or more location identifiers corresponding to at least one of the start time of execution of the at least one vehicle function or the end time of execution of the at least one vehicle function.

8. The method of claim 1, wherein the one or more sensor datapoints corresponding to the one or more vehicle functions are collected from one or more sensors comprising at least one of a camera, a lidar, a millimeter wave radar, a GPS, or an inertia measurement unit (IMU), a wheel speed sensor, a speed sensor, an acceleration sensor, a steering angle sensor, a rain sensor, or an ambient light sensor.

9. The method of claim 1, wherein the one or more vehicle functions comprise at least one of:
one or more vehicle maneuver functions, or one or more vehicle auxiliary functions.

10. The method of claim 9, wherein the one or more vehicle maneuver functions comprise at least one of: cruise control functions, braking functions, lane assist functions, steering functions, gear shift functions using stick shift and clutch, paddle shifters, or automatic transmission, or driving functions.

11. The method of claim 9, wherein the one or more vehicle auxiliary functions comprise at least one of: headlight control functions, wiper control functions, heating, ventilation and air conditioning (HVAC) control functions, window defrost function, or SOS functions.

12. A system, comprising:
a memory configured to store computer executable instructions; and
one or more first processors configured to execute the instructions to:
collect one or more sensor datapoints corresponding to one or more vehicle functions, wherein each sensor datapoint of the one or more sensor datapoints comprises an autonomous functionality status identifier of the respective vehicle function of the one or more vehicle functions;
filter each sensor data point into one of autonomous control data or manual control data to generate filtered data, based on the corresponding autonomous functionality status identifier of the respective sensor data point; and
generate at least one of a first dataset or a second dataset, based on the filtered data, wherein the first dataset corresponds to the autonomous control data, and wherein the second dataset corresponds to the manual control data.

13. The system of claim 12, wherein the one or more first processors are further configured to control at least one of:
a second processor for training, using the first dataset, a first machine learning (ML) model to optimize a performance of the one or more vehicle functions; or
a third processor for training, using the second dataset, a second machine learning (ML) model to update a map database.

14. The system of claim 12, wherein the one or more first processors are further configured to determine driver behavior data of a driver of at least one vehicle, based on the second dataset.

15. The system of claim 12, wherein each sensor datapoint of the one or more sensor datapoints further comprises a functionality identifier of a respective vehicle function of the one or more vehicle functions, one or more timestamps associated with the respective vehicle function of the one or more vehicle functions, and one or more location identifiers associated with the respective vehicle function of the one or more vehicle functions.

16. The system of claim 12, wherein the first dataset comprises a functionality identifier of at least one vehicle function of the one or more vehicle functions executed under autonomous mode, one or more timestamps corresponding to at least one of a start time of execution of the at least one vehicle function or an end time of execution of the at least one vehicle function, one or more location identifiers corresponding to at least one of the start time of execution of the at least one vehicle function or the end time of execution of the at least one vehicle function.

17. The system of claim 12, wherein the second dataset comprises a functionality identifier of at least one vehicle function of the one or more vehicle functions executed under manual mode, one or more timestamps corresponding to at least one of a start time of execution of the at least one vehicle function or an end time of execution of the at least one vehicle function, one or more location identifiers corresponding to at least one of the start time of execution of the at least one vehicle function or the end time of execution of the at least one vehicle function.

18. The system of claim 12, wherein the one or more sensor datapoints corresponding to the one or more vehicle functions are collected from one or more sensors comprising at least one of a camera, a lidar, a millimeter wave radar, a GPS, or an inertia measurement unit (IMU), a wheel speed sensor, a speed sensor, an acceleration sensor, a steering angle sensor, a rain sensor, or an ambient light sensor.

19. The system of claim 12, the one or more first processors are further configured to control at least one of:
a second processor to optimize a performance of the one or more vehicle functions, based on the first dataset, wherein the first processor utilizes one or more of first heuristic algorithms, first statistical analysis or first user inputs corresponding to manual review of the first dataset to optimize the performance of the one or more vehicle functions; or
a third processor to update a map database, based on the second dataset, wherein the second processor utilizes one or more of second heuristic algorithms, second statistical analysis or second user inputs corresponding to manual review of the second dataset to update the map database.

20. A non-transitory computer readable storage medium including one or more sequences of one or more instructions which, when executed by one or more processors, cause an apparatus to at least perform:
collecting one or more sensor datapoints corresponding to one or more vehicle functions, wherein each sensor datapoint of the one or more sensor datapoints comprises an autonomous functionality status identifier of the respective vehicle function of the one or more vehicle functions;
filtering each sensor data point into one of autonomous control data or manual control data to generate filtered data, based on the corresponding autonomous functionality status identifier of the respective sensor data point; and
generating at least one of a first dataset or a second dataset, based on the filtered data, wherein the first dataset corresponds to the autonomous control data, and wherein the second dataset corresponds to the manual control data.
